(19) United States
(12) Patent Application Publication
(10) Pub. No.: US 2014/0370920 A1
(43) Pub. Date: Dec. 18, 2014

(54) SYSTEMS AND METHODS FOR GENERATING AND EMPLOYING AN INDEX ASSOCIATING GEOGRAPHIC LOCATIONS WITH GEOGRAPHIC OBJECTS

(71) Applicant: Google Inc., Mountain View, CA (US)

(72) Inventors: Fabrice Caillette, Baech (CH); Mugurel Ionut Andreica, Bucharest (RO); Diana Stroe, Zurich (CH); Tomasz Malesinski, Erlenbach (CH)

(21) Appl. No.: 13/678,254

(22) Filed: Nov. 15, 2012

(51) Int. Cl. H04W 4/02

(52) U.S. Cl. CPC H04W 4/021
USPC 455/456.3

(57) ABSTRACT

A computer-implemented method that includes for each geographic object of a geo-object set, identifying, using a computer, one or more geographic cells of a geographic mapping that each correspond to a geographic area proximate to at least a portion of a geometry of the geographic object and assigning a weighting value to each of the one or more geographic cells identified as corresponding to a geographic area proximate to at least a portion of a geometry of the geographic object such that the one or more geographic cells are associated with the geo-object. The method also including, for each geographic cell assigned one or more weighting values, aggregating the one or more weighting values assigned to the geographic cell to generate an aggregated weighting value for the geographic cell, identifying a set of dense geographic cells (each geographic cell of the set of dense geographic cells having an aggregated weighting value that satisfies a weighting threshold criteria) and generating an index associating each of the one or more geographic cells of the set of dense geographic cells with one or more geographic objects associated with the geographic cell.

### BACKGROUND OF THE INVENTION

1. Field of the Invention

This invention relates generally to identifying nearest-neighbors and more particularly to identifying geographic objects near a geographic location.

2. Description of the Related Art

Nearest-neighbor searches are often employed to find points that are close to one another in a given space. In the context of geographic mappings, a nearest-neighbor search may be employed to identify geographic objects that are closest to a given location. For example, where a user submits a request to locate a gas station nearest to their location, a database of any number of points of interest may be searched to identify the gas-station closest to the user's current location.

Various techniques have been employed in the past to execute nearest-neighbor searches. For example, in a linear approach, a distance is computed from the query point (e.g., the user's location) to every other point in the database (e.g., the location of every point of interest in the database). Unfortunately, these techniques may require a large amount of processing to generate the search results. For example, where a database contains an extremely large number of points of interest, determining the distance between the query point and each of the points of the database may require a large amount of processing and time and, as a result, increase the amount of time it takes to provide an answer to the query. Upon submitting a request for a gas station nearest to a location, a user may have to wait for an extended period of time as the system processes the points in the database individually to determine a distance between the query point and each of the points of the database to identify the nearest gas-station. As a result, systems for performing nearest-neighbor queries may be complex and may experience delays that can detrimentally affect a user's experience with the system.

### SUMMARY OF THE INVENTION

Various embodiments of methods and apparatus for identifying geographic objects near a given geographic location are provided herein. In some embodiments, provided is a computer-implemented method that includes for each geographic object of a geo-object set, identifying, using a computer, one or more geographic cells of a geographic mapping that each correspond to a geographic area proximate to at least a portion of a geometry of the geographic object and assigning a weighting value to each of the one or more geographic cells identified as corresponding to a geographic area proximate to at least a portion of a geometry of the geographic object such that the one or more geographic cells are associated with the geo-object. The method also including, for each geographic cell assigned one or more weighting values, aggregating the one or more weighting values assigned to the geographic cell to generate an aggregated weighting value for the geographic cell, identifying a set of dense geographic cells (each geographic cell of the set of dense geographic cells having an aggregated weighting value that satisfies a weighting threshold criteria) and generating an index associating each of the one or more geographic cells of the set of dense geographic cells with one or more geographic objects associated with the geographic cell.

In some embodiments, provided is a non-transitory computer readable storage medium having computer-executable program instructions stored thereon that are executable by a computer to cause steps including identifying, using a computer, one or more geographic cells of a geographic mapping that each correspond to a geographic area proximate to at least a portion of a geometry of the geographic object and assigning a weighting value to each of the one or more geographic cells identified as corresponding to a geographic area proximate to at least a portion of a geometry of the geographic object such that the one or more geographic cells are associated with the geo-object. The steps also including, for each geographic cell assigned one or more weighting values, aggregating the one or more weighting values assigned to the geographic cell to generate an aggregated weighting value for the geographic cell, identifying a set of dense geographic cells (each geographic cell of the set of dense geographic cells having an aggregated weighting value that satisfies a weighting threshold criteria) and generating an index associating each of the one or more geographic cells of the set of dense geographic cells with one or more geographic objects associated with the geographic cell.

In some embodiments, provided is a system including a processor, a memory and a location module stored on the memory. The location module is configured to be executed by the processor to cause identifying, using a computer, one or more geographic cells of a geographic mapping that each correspond to a geographic area proximate to at least a portion of a geometry of the geographic object and assigning a weighting value to each of the one or more geographic cells identified as corresponding to a geographic area proximate to at least a portion of a geometry of the geographic object such that the one or more geographic cells are associated with the geo-object. The location module also providing, for each geographic cell assigned one or more weighting values, aggregating the one or more weighting values assigned to the geographic cell to generate an aggregated weighting value for the geographic cell, identifying a set of dense geographic cells (each geographic cell of the set of dense geographic cells having an aggregated weighting value that satisfies a weighting threshold criteria) and generating an index associating each of the one or more geographic cells of the set of dense geographic cells with one or more geographic objects associated with the geographic cell.

In some embodiments, provided is a computer-implemented method of generating an index associating geographic objects with geographic cells of a geo-mapping. The method includes obtaining a geo-object set indicative of a plurality of geographic objects that are each associated with a given geographic location, for each geographic object of the geo-object set, associating the geographic object with one or more dense cells including cells of the geo-mapping each having an area that is proximate the geographic object, for each dense cell of the geo-mapping, identifying a candidate set of geo-objects including the geographic objects associated with the dense cell and filtering the candidate set of geo-objects to generate a set of geo-objects corresponding to the dense cell. Filtering the candidate set of geo-objects includes excluding geographic objects that could never be the closest geo-object to a geographic location within the geographic cell. The method also includes for each dense cell of the geo-mapping, associating the dense cell with a set of non-dense cells including cells of the geo-mapping each having an area that is proximate the dense cell, for each non-dense cell of each set of non-dense cells identifying a set of geo-objects corresponding to the non-dense cell, the set of geo-objects corresponding to the non-dense cell including, for each dense cell associated with the dense cell, a geo-object associated with the dense cell, and generating an index associating each dense cell of the geo-mapping to a set of geo-objects corresponding to the dense cell and associating each non-dense cell of the geo-mapping to a set of geo-objects corresponding to the non-dense cell.

### BRIEF DESCRIPTION OF THE DRAWINGS

FIG. 1 is a diagram that illustrates an exemplary nearest-neighbor location system in accordance with one or more embodiments of the present technique.

FIG. 2A is a diagram that illustrates an exemplary geo-map in accordance with one or more embodiments of the present technique.

FIG. 2B is a diagram that illustrates an exemplary set of neighboring cells in accordance with one or more embodiments of the present technique.

FIG. 3 is a diagram that illustrates an exemplary map-reduce processing system in accordance with one or more embodiments of the present technique.

FIG. 4A is a flowchart that illustrates a method of generating an index of dense cells and associated geo-objects in accordance with one or more embodiments of the present technique.

FIG. 4B is a flowchart that illustrates a method of generating an index of dense cells and proximate geo-objects in accordance with one or more embodiments of the present technique.

FIGS. 5A and 5B are exemplary mappings including geo-objects in accordance with one or more embodiments of the present technique.

FIGS. 6A and 6B depict exemplary weighted cell mappings in accordance with one or more embodiments of the present technique.

FIG. 7A is a diagram that illustrates a mapping of a set of geo-objects associated with a given dense cell in accordance with one or more embodiments of the present technique.

FIG. 7B is a diagram that illustrates a mapping of a filtered set of geo-objects associated with a dense cell in accordance with one or more embodiments of the present technique.

FIG. 8 is a flowchart that illustrates a method of identifying a set of candidate non-dense cells in accordance with one or more embodiments of the present technique.

FIGS. 9A-9C are exemplary mappings of candidate non-dense cells associated with dense cells in accordance with one or more embodiments of the present technique.

FIG. 10 is a diagram that illustrates an exemplary mapping of dense cells and representative cells associated with a non-dense cell in accordance with one or more embodiments of the present technique.

FIG. 11 illustrates exemplary index tables in accordance with one or more embodiments of the present technique.

FIG. 12 is a flowchart that illustrates a method of serving a nearest-neighbor query in accordance with one or more embodiments of the present technique.

FIG. 13 is a block diagram that illustrates a nearest-neighbor query system in accordance with one or more embodiments of the present technique.

FIG. 14 is an exemplary mapping including a geolocation and geo-object objects in accordance with one or more embodiments of the present technique.

FIG. 15 is a diagram that illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for processing and responding to nearest-neighbor queries. In some embodiments, an index is generated that associates cells of a geographic mapping (“geo-mapping”) to geo-graphic objects (“geo-objects”) that are located in and/or proximate the cell (e.g., within a given radius). In certain embodiments, upon receiving a nearest-neighbor query specifying a given geographic location (e.g., geolocation), a cell of the geo-mapping containing the geographic location is identified, and the index is accessed to identify geo-objects corresponding to the cell. In some embodiments, the geo-objects corresponding to the cell are processed to identify one or more of the geo-objects that are closest to the geolocation.

In some embodiments, an index is generated via processing of each geo-object of a geo-object set corresponding to the geo-mapping. In certain embodiments, each of the geo-objects are processed to identify nearby cells that are associated with the geo-object. In some embodiments, the nearby cells are each assigned a weighting attributed to the geo-object. In certain embodiments, the process is repeated for each object such that some cells have multiple weightings attributed to multiple geo-objects that are nearby the cell. In some embodiments, the weightings attributed to each of the geo-objects are aggregated (e.g., totaled) to generate an aggregated weighting for each of the cells. In certain embodiments, some of the cells are ignored/filtered based on their weightings while others are retained. In some embodiments, cells having a high weighting value (e.g., that exceeds a weighting threshold) are filtered out while smaller cells in the same area having a low weighting value (e.g., that falls within the weighting threshold) are retained. In some embodiments, if a cell is of a high level of granularity (e.g., has a small area), the cell may be retained in the resulting filtered set of cells despite the cell having an aggregated weight that exceeds a weighting threshold. In some embodiments, the filtering based on the aggregated weighting may provide for selecting cells that have approximately the same number of geo-objects associated therewith, or that are of such a small area that it is not desirable to further subdivide them even though they are associated with a large number of geo-objects. In certain embodiments, as a result, most of the cells of the resulting filtered set of cells have a similar number of objects associated therewith due to the cells generally having a lower aggregate weight that ensure that the cells do not have an excessively large number of geo-objects associated therewith.

In some embodiments, processing of geo-objects associated with the cell may involve a similar amount of complexity as most of the cells have a similar number of geo-objects associated therewith. In certain embodiments, the resulting filtered set of cells may be used to generate a listing of cells having similar “density” (e.g., associated with a similar number/weighting of objects) and falling within a desired level of granularity (e.g., cells of a desired range of area). These cells may be referred to as dense cells. In some embodiments, each of the dense cells may be associated with a given set of one or more geo-objects. In certain embodiments, a cell-object index may include an entry for each dense cell and that specifies the set of geo-objects corresponding to the dense cell. Due to most of the dense cells being associated with a similar number of objects or less (with the exception of cells of a high granularity that may be associated with a large number of geo-objects), where a query point is located in a dense cell, processing of the set of geo-objects associated with the dense cell may generally be deterministic (e.g., take a given amount of time or less) as a similar number of objects may be processed. Although processing of cells of a high granularity that may be associated with a large number of geo-objects may involve additional processing, the technique may help to reduce the frequency with which processing times vary excessively.

In certain embodiments, cells proximate dense cells (“non-dense cells”) are identified and processed to identify geo-objects that are nearby the non-dense cells (e.g., within a maximum distance/radius of the non-dense cell). In some embodiments, the non-dense cells are associated with one or more of the geo-objects associated with nearby dense cells. In certain embodiments, a non-dense cell may be associated with a single one of the geo-objects associated with the closest set of dense cells. In some embodiments, associating less than all of the geo-objects with the non-dense cells may result in an acceptable approximation of the closest object although another of the geo-objects in the dense cell may be closer. In certain embodiments, associating less than all of the geo-objects with the non-dense cells may improve performance as fewer objects may be associated with the non-dense cell and, thus, less geo-objects may have to be processed where a query point is located in the non-dense cell. In certain embodiments, the trade-off in accuracy and performance may be warranted as the non-dense cells may not have geo-objects located nearby (e.g., within a minimum distance/radius of the non-dense cell), and at the extended distance an approximation of the closest geo-object may be suitable. In some embodiments, the cell-object index may include an entry for each non-dense cell associated with at least one geo-object corresponding thereto.

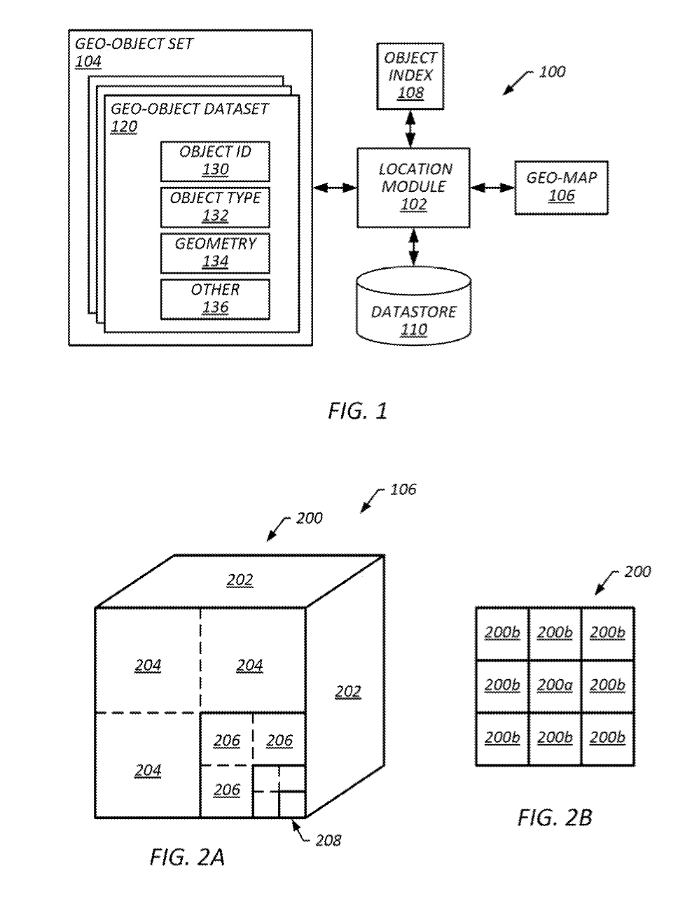

FIG. 1 is a diagram that illustrates an exemplary nearest-neighbor location system (“system”) 100 in accordance with one or more embodiments of the present technique. As depicted, system 100 may include a location module 102, a geographic object set (e.g., geo-object set) 104, a geographic map (e.g., geo-map) 106, an geographic object index (e.g., geo-object index) 108, and a datastore 110.

Location module 102 may include program instructions that are executable by a computer system to perform at least some or all of the functionality described herein with regard to at least system 100. In some embodiments, location module 102 may provide for processing of nearest-neighbor queries. For example, location module 102 may include an application or similar processing environment that provides for identifying one or more geo-objects of geo-object dataset 104 that are nearest to a given geolocation. In some embodiments, location module 102 may be implemented on a computer system similar to that of computer system 2000 described in more detail below with regard to at least FIG. 15.

Geo-object set 104 may be indicative of a plurality of geographic objects (e.g., “geo-objects”). A geo-object may include an geographic entity having a geolocation associated therewith. For example, a geo-object may include a street, a residence, a business, a landmark, a park, a city, a state, a geographic feature (e.g., lake, river, mountain, or the like), a gas station, a grocery store, a hotel/motel, a post-office, a police station or the like.

Geo-object set 104 may include a plurality of geo-objects datasets 120. Each of geo-object datasets 120 may correspond to a given geo-object of geo-object set 104. In some embodiments, each of geo-objects datasets 120 may include information associated with a particular geo-object of geo-object set 104. For example, each geo-object dataset 120 may include an object identifier (e.g., object ID) 130, a type 132, a geometry 134 and/or other information 136 associated with a particular one of the geo-objects of geo-object set 120.

In some embodiments, object ID 130 of a given geo-object dataset 120 may uniquely identify the given geo-object dataset 120 and/or the corresponding geo-object from some or all of the other geo-object datasets 120 of geo-object set 104 and/or their corresponding geo-objects. For example, object ID 130 of a given geo-object dataset may include a serial number (e.g., “1234”) that is unique to the given geo-object dataset 120 and/or the geo-object corresponding to the to the given geo-object dataset 120. In some embodiments, object ID 130 may include a name of the geo-object. For example, object ID may include the name “Main Street”.

In some embodiments, object type 132 of a given geo-object dataset 120 may be indicative of a one or more types/categories of the geo-object corresponding to the given geo-object dataset 120. For example, object type 132 may specify a type/category of “gas-station”, thereby indicating that the corresponding geo-object includes a gas-station. Object type 132 may specify any suitable type/category. For example, object type may specify various types/categories including a street, a residence, a business, a landmark, a park, a city, a state, a geographic feature (e.g., lake, river, mountain, or the like), a gas station, a grocery store, a hotel/motel, a post-office, a police station or the like.

In some embodiments, geometry 134 of a given geo-object dataset 120 may be indicative of one or more geometric and/or geographic features/characteristics associated with the geo-object corresponding to the given geo-object dataset 120. For example, geometry may specify a geolocation and/or a shape associated with the geo-object corresponding to the given geo-object dataset 120. In some embodiments, a shape may be defined by one or more, points, edges/lines and/or curves. For example, where the geo-object corresponding to the given geo-object dataset 120 includes a street, geometry 134 may specify a series of lines connected at vertices that approximately follow a path of the street. In some embodiments, a shape may include one or more, points, edges/lines and/or curves that define a boundary of a given geographic area associated with the geo-object. For example, where the geo-object corresponding to the given geo-object dataset 120 includes a city, geometry 134 may specify a polygon at least approximating the city limits of the city. In some embodiments, a geolocation may include one or more sets of geographic coordinates (e.g., latitude/longitude) corresponding to a geographic location of one or more portions of the geo-object corresponding to the given geo-object dataset 120. For example, a geolocation may specify geographic coordinates of vertices of edges/lines defining a shape of the geo-object corresponding to the given geo-object dataset 120. Other information 136 may include various types of information associated with the geo-object corresponding to the given geo-object dataset 120. For example, other information may include alternative names of the object, a brief description of the object (e.g., hours of operation of a business), and so forth.

Geo-map 106 may include data that is indicative of a geographic mapping of some or all of the earth's surface. In some embodiments, geo-map 106 may include a mapping of a given geographic region that is sub-divided into sub-regions (e.g., cells/tiles). For example, geo-map 106 may include a grid defining cells that cover some or all of the earth's surface.

FIG. 2A is a diagram that illustrates an exemplary geo-map 106 including cells 200 in accordance with one or more embodiments of the present technique. Cells 200 may each include a polygon (e.g., square) that represents a given geographic area. For example, a given cell 200 may represent a one-kilometer by one-kilometer square area. As described herein, a cell 200 may be subdivided into smaller/higher-level cells. For example, a cell 200 representing a two-kilometer by two-kilometer square area may be subdivided into four quadrants to generate four sub-cells (e.g., child cells) nested in the cell and each representing a one-kilometer by one-kilometer square area. Cells of a larger area may be referred to as lower-level cells having a lower granularity and cells of a smaller area may be referred to a higher-level cells having a high granularity. Accordingly, higher-level cells may have a smaller size than lower-level cells. Cells of the same level may have the same or similar sizes and shapes.

Geo-map 106 may include a two-dimensional mapping of a three-dimensional surface. Geo-map 106 may include a mapping having any number of cells. As depicted, geo-map 106 may include a cube like shape having eight faces onto which a mapping of the earth's surface is projected (e.g., as if a globe was positioned inside of the cube, and a light was illumined inside of the globe to project a map of the earth onto the faces of the cube). Each of the faces may be referred to as a cell of a given level (e.g., level “1”). In some embodiments, the cells may be subdivided into smaller cells nested therein of a higher level (e.g., level “2”). For example, each of the eight faces of the cube may be referred to as first level cells 202. Each of first-level cells 202 may be subdivided into second-level cells 204, each of second-level cells 204 may be may be subdivided into third-level cells 206, each of third-level cells 206 may be subdivided into fourth-level cells 208 and so forth. Each of the cells of a given level may be of a similar size and/or shape.

In some embodiments, each cell may include a unique identifier (e.g., cell value). For example, each cell may represented by a 64-bit number. Where cells 202 represent a top/high-level cell, the first 3-bits of the 64-bit number may be used to distinguish between the eight first-level cells 202, the next two bits (e.g., bits 4 and 5) may be used to distinguish between the four second-level cells 204, the next two bits (e.g., bits 6 and 7) may be used to distinguish between the four third-level cells 206, the next two bits (e.g., bits 8 and 9) may be used to distinguish between the four fourth-level cells 208, and so forth. Accordingly, each cell 200 may be uniquely identified by the 64-bit identifier. In the context of a 64-bit identifier and the techniques described herein for subdividing cells into quadrants, the smallest cell (e.g., the cell with the highest granularity) may represent an approximately two-meter by two-meter region of the earth's surface.

In some embodiments, relative relationships of cells may be indicated by a given naming convention. For example, with regard to a given third-level cell 206, the second level-cell 204 containing cell 206 may be referred to as the parent of the given third-level cell 206, the first level-cell 202 containing the given second level-cell 204 and the given third-level cell 206 may be referred to as the parent of the given second level-cell 204 and the grand-parent of the given third-level cell 206, and so forth. Cells of the same level that are contained by the same parent cell may be referred to as a siblings. For example, the illustrated third-level cells 206 that fall within the same second-level cell 204 may be referred to as siblings of one another. Children, grandchildren and so forth of a cell may be referred to as descendants of the cell. For example, any of the illustrated fourth level-cells 208 may be descendants of the second-level cell 202 containing them. Parents, grandparents, and so forth may be referred to as ancestors. For example, second level-cell 202 containing a fourth-level cells 208 may be an ancestor of the fourth-level cells 208.

In some embodiments, a cell having a boundary that abuts or otherwise contacts a boundary of a given cell may be referred to as a neighbor of the given cell. FIG. 2B is a diagram that illustrates an exemplary set of neighboring cells 200b in accordance with one or more embodiments of the present technique. For example, cell 200a includes eight neighboring cells 200b.

Geo-object index (e.g., cell-object index) 108 may include an index that associates geographic areas (e.g., cells) with one or more geo-objects located in or near the geographic area. In some embodiments, geo-object index 108 may include an index of cells 200 of geo-map 106 and, for each given cell 200, a listing of one or more geo-objects of geo-object set 104 that are proximate the geographic area of the given cell 200 or otherwise associated with the given cell. The listing of geo-objects for a cell may include a subset of the geo-objects of geo-object set 104. The subset of the geo-objects (as opposed to the entire set of geo-objects), may be considered/processed when responding to a nearest-neighbor query corresponding to a geolocation (e.g., a query point) located within the cell. In some embodiments, geo-object set 104 may be pre-processed by location module 102 to generate geo-object index 108 including a listing of cells of geo-map 106 and, for each cell, a listing of object ID's 130 corresponding to a subset of geo-objects that are located proximate to the given cell. Upon receiving a nearest-neighbor query associated with a given geographic location (e.g., a given query point), location module 102 may determine a given cell of geo-map 106 that contains the query point, access geo-object index 108 to identify the listing/subset of geo-objects corresponding to the given cell that contains the query point, process the subset of geo-objects to determine one or more geo-objects that are nearest the query point, and respond to the nearest-neighbor query with information corresponding to the one or more geo-objects nearest the query point.

In some embodiments, datastore 110 may include one or more databases of geographic information or similar memory locations storing geographic information. For example, datastore 108 may include a database storing geo-object set 104, geo-map 106 and/or geo-object index 108.

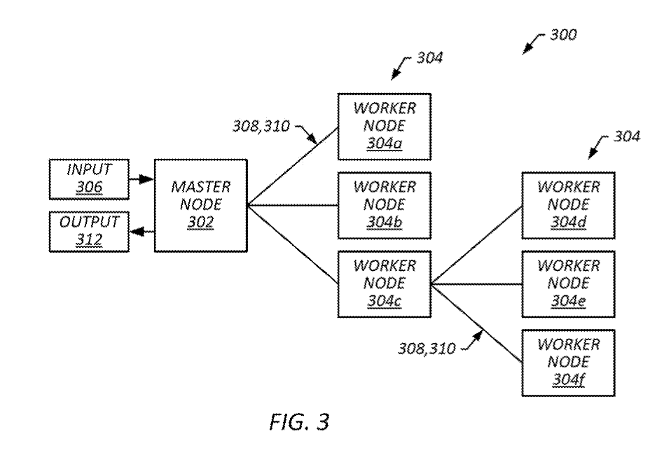

As described in more detail below, in some embodiments, some portions of processing may be distributed amongst a plurality of computing devices. For example, processing tasks may employ MapReduce techniques that may enable parallel execution of task on a large cluster of processing devices. FIG. 3 is a diagram that illustrates an exemplary map-reduce processing system 300 in accordance with one or more embodiments of the present technique. Map-reduce processing system 300 may include a master node 302 and a plurality of worker nodes (e.g., mappers) 304a-304f (collectively referred to herein as worker nodes 304). Embodiments may include any number of suitable worker nodes 304. Each of the nodes may include computer/processing devices. In some embodiments, nodes may include servers of a “server farm” including networked of servers.

In some embodiments, worker nodes 304 may be logically arranged in a tree structure. For example, the illustrated embodiments include an exemplary logical map reduce processing structure including three worker nodes that make up a first level of worker nodes (e.g., worker nodes 304a-304c) and three worker nodes that make up a second level of worker nodes (e.g., worker nodes 304d-304f). Embodiments may include any number, levels and/or arrangements of suitable worker nodes.

In a map step, master node 302 may receive an input problem, partition the input into smaller sub-problems, and distribute the sub-problems to worker nodes 304. For example, master node 302 may receive an input problem 306 and partition input problem 306 into three sub-problems that are distributed to a first level including three worker nodes 304a, 304b and 304c. A worker node may partition the sub-problem into additional sub-problems that are distributed to other levels of worker nodes. For example, worker node 304c may receive a sub-problem 308 and partition sub-problem 308 into three sub-problems 308 that are distributed to three worker nodes 304d, 304e and 304f. Worker node 304c may be referred to as a mater node for worker nodes 304d-304f. Worker nodes may process the sub-problems and pass corresponding answers to their respective master node. For example, worker nodes 304d-304f may pass answers 310 to their master node (e.g., worker node) 304c and worker nodes 304a-304c may pass answers 310 to master node 302.

In a reduce step, a master node may combine answers from multiple worker nodes to generate an answer to the problem received at the master node. For example, worker node 304c may combine answers 310 from worker nodes 304d-304f to generate an answer 310 to a sub-problem 308, and master node 302 may combine answers 310 from worker nodes 304a-304c to generate an output 312 that may include an answer to the original problem received at master node 302.

Map and reduce functions may be defined by a data structure including (key, value) pairs. A map function may receive a pair of data in one data domain and return a list of pairs in a different data domain (e.g., Map (k1, v1)→list (k2, v2)). The map function may be applied in parallel to every item in an input dataset to produce a list of (k2,v2) pairs for each map call. A MapReduce framework may subsequently employ a reduce function to collect all pairs with the same key from all lists and group them together to create one group for each one of the different generated keys. The reduce function may be applied in parallel to each group, which in turn produces a collection of values in the same domain (e.g., Reduce (k2, list v2)→list (v3)). Each reduce call may produce either one value, an empty return, or more than one value. The returns of all calls are collected as the desired result list. Accordingly, the MapReduce framework may transform a list of (key, value) pairs into an output 312 including a list of values for each common key.

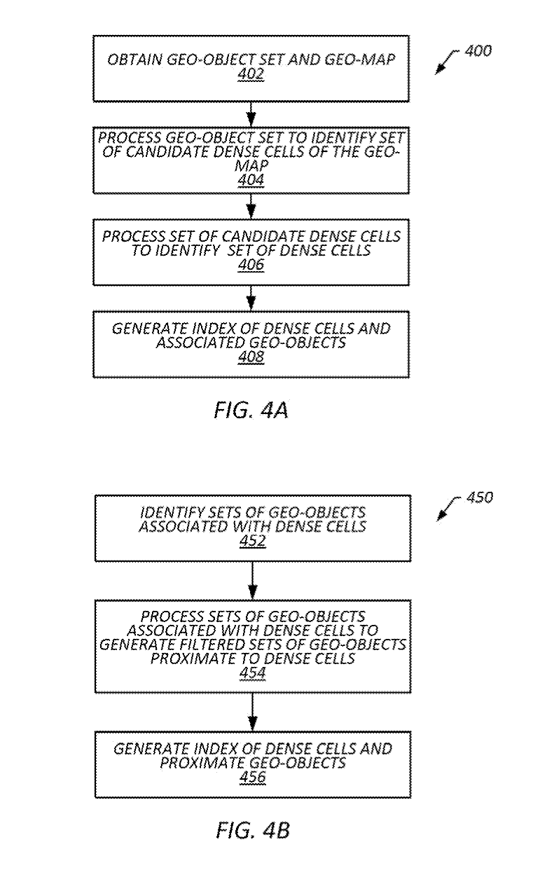

FIG. 4A is a flowchart that illustrates a method 400 of generating an index of dense cells and associated geo-objects in accordance with one or more embodiments of the present technique. As discussed in more detail below, FIG. 4B is a flowchart that illustrates a method of generating an index of dense cells and proximate geo-objects in accordance with one or more embodiments of the present technique. In some embodiments, a dense cell may refer to a cell that is proximate (e.g. close to) at least a portion of one or more geo-objects in a given space. For example, a dense cell may include a geographic area located a distance that is less than or equal to a minimum radius (e.g., Rmin) from any part of a geographic object. In some embodiments, a non-dense cell may refer to a cell that is not proximate (e.g., that is far from) at least a portion of one or more geo-objects. For example, a non-dense cell may include a geographic area located a distance that is greater than the minimum radius (e.g., Rmin) from any part of a geographic object and/or non-dense cell may include a geographic area located a distance that is less than or equal a maximum radius (e.g., Rmax) from any part of a geographic object and/or a dense cell.

Method 400 may include obtaining a geo-object set and a geo-map, as depicted at block 402. Obtaining a geo-object set may include retrieving geo-object set 104 from datastore 110. Obtaining a geo-map may include retrieving geo-map 106 from datastore 110.

Method 400 may include processing the geo-object set to identify a set of candidate dense cells of the geo-map, as depicted at block 404. Processing the geo-object set to identify a preliminary set of candidate dense cells of the geo-map may include processing each of the geo-object datasets 120 of geo-object set 104 to identify cells 200 of geo-map 106 that are located proximate to the geo-objects corresponding to geo-object datasets 120. For example, a specified geometry 134 for each geo-object dataset 120 may be processed to identify cells 200 that are located near at least a portion of the geometry of each geo-object.

In some embodiments, geo-objects (“O”) of geo-object set 104 may be processed in accordance with a MapReduce technique. Such a technique may enable geo-objects to be processed in parallel by one or more worker nodes to identify, for each geo-object, a corresponding set of one or more cells 200 that are near the given geo-object. In some embodiments, input/problem 306 may define a problem requesting an identity of cells 200 that are proximate one or more of the geo-objects of geo-object set 104. Input/problem 306 may include geo-object set 104, geo-map 106, additional processing criteria that is provided to master node 302.

In some embodiments, additional processing criteria may specify a cell-level range including a minimum cell-level (“MinCellLevel”) and a maximum cell-level (“MaxCellLevel”), diameter fraction (“Frac”), and/or a minimum radius (“Rmin”). Minimum cell-level may define the lowest-level (e.g., largest cell size) to be considered during processing as described herein. Maximum cell-level may define a highest-level (e.g., smallest-cell-size) to be considered during processing as described herein. Diameter fraction may specify a percentage of a diameter of a given cell to be considered when assessing the proximity of other nearby cells as described herein. A diameter may include the largest distance between two points of a cells. Where a cell is a polygon, the diameter may denote the largest distance between two vertices of the polygon. For example, with regard to a square cell, the diameter may be the distance between opposite vertices of the square cell. A fractional distance (“DFrac”) may be defined as the diameter fraction (“Frac”) multiplied by a diameter (“Dcell”) of a cell. The fractional distance may be adjusted to control the proximity of neighboring cells to be associated with a geo-object as described herein.

In some embodiments, master node 302 may divide the input/problem 306 into sub-problems that are forwarded to various worker nodes 304 for processing. For example, where geo-object set 104 includes one-thousand geo-object datasets 120 corresponding to one-thousand geo-objects, master node 302 may break input/problem 306 into one-thousand sub-problems 308 that are each distributed to respective ones of the one-thousand different worker nodes 304. Each sub-problem 310 may corresponding to a given geo-object and request an identity of cells that are proximate the given geo-object. Each sub-problem may be processed by a given worker node 304 to identify cells 200 that are near a given geo-object associated with the sub-problem, and the given worker node 304 may return to master node 302 a corresponding answer 310 that identifies one or more cells 200 that are near the given geo-object. Master node 302 may reduce the answers into a listing of cells and, for each of the cells, a corresponding listing of geo-objects that are associated with the given cell. Embodiments may include distribution of sub-problems to any suitable number and/or logical arrangement of worker nodes.

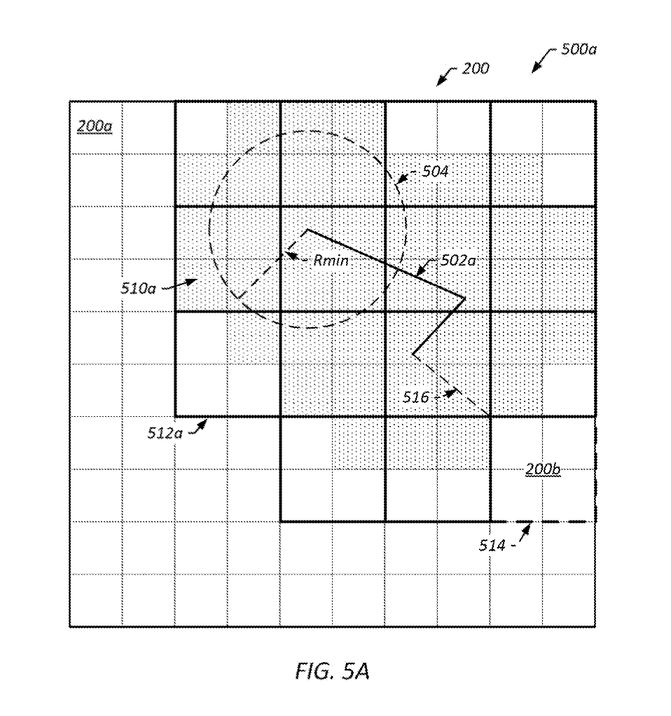

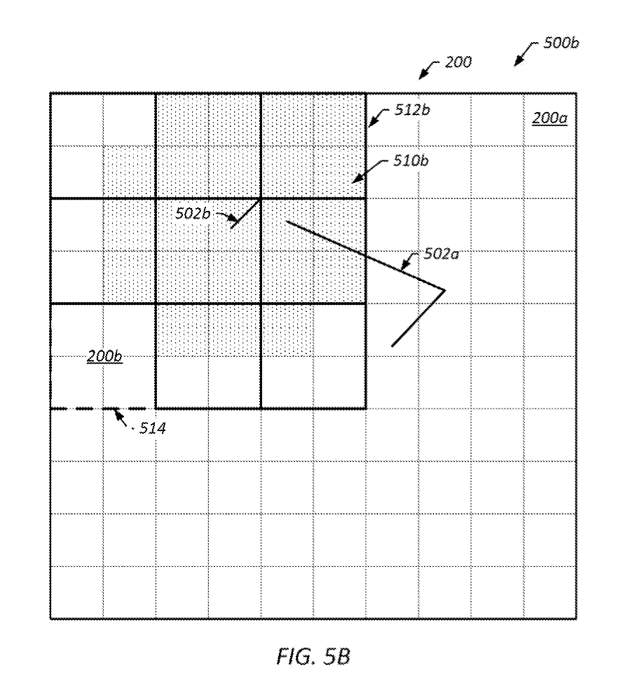

FIG. 5A depicts an exemplary mapping 500a including a geo-object 502a in accordance with one or more embodiments of the present technique. In the illustrated embodiment, object 502a includes two line segments having endpoints sharing a single common vertex. A dashed circle 504 centered at the leftmost end-point of the line segments includes a radius equal to a specified minimum radius (Rmin). Mapping 500 may include a grid that defines multiple levels of cells 200. Mapping 500 may include a 10×10 grid defining cells 200a at a maximum cell-level of a specified cell-level range. Mapping 500 may include a 5×5 grid defining cells 200b at a minimum cell-level of the specified cell-level range. In some embodiments, cells 200a may include cells 200 of a third-level and cells 200b may include cells 200 of a second-level. Each of cells 200b may be a parent/ancestor to four of cells 200a. The minimum radius (Rmin) and the cell-level range may be specified by input problem 306.

In some embodiments, processing of a sub-problem for a given geo-object may include identifying all cells within a specified range of cell-levels that are within a given distance of the given geo-object. For example, where a problem specifies a cell level range of “2-3” (e.g., a maximum-level of “3” and a minimum-level of “2”) and a minimum radius (Rmin) of one-kilometer, processing of the sub-problem for a given geo-object may include identifying all third-level cells 200a and/or second-level cells 200b having at least a portion of their area falling within one-kilometer of any portion of the geo-object. With regard to FIG. 5A, where a cell level range of “2-3” and a minimum radius (Rmin) of one-kilometer is specified by problem 306, processing of a sub-problem for geo-object 502a may include identifying a set of third-level cells 200a and/or second-level cells 200b (e.g.,) each having at least a portion of their area falling within one-kilometer of at least a portion of geo-object 502a (e.g., a third-level cell set 510a including the forty-one shaded cells 200a and/or second-level cell set 512a including the fourteen outlined second-level cells 200b). Notably, if the center of circle 504 is swept along the length of object 502a, at least a portion of each of the shaded third-level cells 200a of third-level cell set 510a and the outlined cells 200b of the second-level cell set 512a would be intersected by at least portion of circle 504, thereby indicating that at least a portion of each of the cells is within the minimum radius (Rmin) of at least a portion of geo-object 502a.

In some embodiments, processing of a sub-problem for a given geo-object may include identifying neighbors of the identified cells that are within a given distance of the geo-object and within the specified cell level range. For example, where a problem specifies a cell level range of “2-3” and a diameter fraction (“Frac”), processing of the sub-problem for a given geo-object may include identifying all neighboring cells of the second-level cell set 510a and/or third-level cell set 512a having at least a portion of their area falling within a fraction distance equal to the diameter of cells at the given level multiplied by the diameter fraction. With regard to FIG. 5A, where a cell level range of “2-3” and a diameter fraction (“Frac”) of “0.7” is specified by problem 306, and where second-level cells 200b have a diameter/diagonal of about 1.4 km such that a neighboring cell must fall within a distance of about 1 km (e.g., about 0.7*1.4 km) of geo-object 502a to be identified as a nearby neighboring cell, processing of a sub-problem for geo-object 502a may include identifying an additional second-level cell 200b (as indicated by dashed lines 514) located to the lower right of object 502a as a nearby neighboring cell. Notably, the distance 516 from geo-object 502a to a portion of the cell may be less than about 1 km. In some embodiments, cells identified as nearby neighboring cells may be added to a corresponding cell set. For example, second-level cell 200b indicated by dashed lines 514 may be added to second-level cell set 512b. Notably, in the illustrated embodiment, no third-level cells are identified as nearby neighboring cells as the minimum radius (Rmin) is sufficiently large to cover nearby third-level cells 200a.

In some embodiments, the set of candidate dense cells of a geo-map may include the cells of the cell sets identified as being proximate the geo-objects of the geo-object set. For example, a set of candidate dense cells of geo-map 106 associated with geo-object 502a may include the second-level cells 200b of second-level cell set 512a and the third-level cells 200a of third-level cell set 510a.

In some embodiments, each geo-object of the geo-object set may be processed to identify a set of candidate dense cells corresponding to the given geo-object. For example, where geo-object set 104 includes a geo-object dataset 120 corresponding to geo-object 502a and another geo-object dataset 120 corresponding to geo-object dataset 502b (see FIG. 5B), each of at least geo-objects 502a and 502b may be processed to identify sets of candidate dense cells corresponding to each of geo-objects 502a and 502b, respectively.

In some embodiments, geo-objects may be processed via separate sub-problems that are distributed between worker nodes. For example, geo-object 502a and geo-object 502b may be processed via two separate sub-problems that are distributed to different worker nodes 304. A first sub-problem to identify a set of candidate dense cells that are near geo-object 502a may be sent from master node 302 to worker node 304a, and a second sub-problem to identify a set of candidate dense cells that are near geo-object 502b may be sent from master node 302 to worker node 304b. Corresponding answers identifying the sets of candidate dense cells for each of the objects may be received at master node 302.

FIG. 5B depicts an exemplary mapping 500b including geo-objects 502a and 502b in accordance with one or more embodiments of the present technique. It should be noted that, although certain embodiments described herein may refer to two geo-objects for illustrative purposes, a geo-object set and corresponding mappings may include any number of geo-objects that are processed in the same or similar manner to identify sets of candidate dense cells corresponding to each respective geo-object.

Geo-object 502b includes a single line segment. Geo-object 502b may include a geo-object corresponding to a geo-object of geo-object set 104. In some embodiments, geo-object 502b may be processed in a similar manner to geo-object 502a to identify a preliminary set of candidate dense cells corresponding thereto. For example, a sub-problem for geo-object 502b may include identifying all cells within a specified cell-level range that are within a given distance of geo-object 502b and/or identifying neighbors of the identified cells that are within a given distance of geo-object 502b. With regard to FIG. 5B, where a cell level range of “2-3” and a minimum radius (Rmin) of one-kilometer is specified by problem 306, processing of a sub-problem for geo-object 502b may include identifying a set of third-level cells 200a and/or second-level cells 200b each having at least a portion of their area falling within one-kilometer of at least a portion of geo-object 502b (e.g., a third-level cell set 510b including the twenty-two shaded cells 200a and a second-level cell set 512b including the eight outlined second-level cells 200b). Further, where a cell level range of “2-3” and a diameter fraction (“Frac”) of “0.7” is specified by problem 306, and where second level cells 200b have a diameter/diagonal of about 1.4 km, processing of a sub-problem for geo-object 502b may include identifying an additional second-level cell 200b (as indicated by dashed lines 514, located to the lower left of object 502a as a nearby neighboring cell. Notably, the distance 516 from geo-object 502a to a portion of the cell may be less than about 1 km. Second-level cell 200b indicated by dashed lines 514 may be added to second-level cell set 512b.

In some embodiments, an answer to a sub-problem for a given geo-object may include a weighted value for each cell associated with the given geo-object. For example, with regard to geo-object 502a, where the weighting includes a value of “1” for cells associated with geo-object 502a, worker node 304a may process the geo-object 502a to identify the set of candidate dense cells corresponding thereto, as described herein, and return an answer assigning/associating each third-level cell 200a of second-level cell set 510a and each second-level cell 200b of second-level cell set 512a with a value of “1”. With regard to geo-object 502b, where the weighting includes a value of “1” for cells associated with geo-object 502b, worker node 304b may process geo-object 502b to identify the set of candidate dense cells corresponding thereto, as described herein, and return an answer assigning/associating each third-level cell 200a of third-level cell set 510b and each second-level cell 200b of second-level cell set 512b with a value of “1”. Notably, the weighting values may include any suitable value. For example, some geo-objects may be associated with higher weighting values, while other geo-objects may be associated with lower weighting values to vary the impact of geo-objects on an aggregated weighting, described below. In some embodiments, a worker node may return to a master node, for each cell of the set of candidate dense cells corresponding to a given geo-object (e.g., for each third-level cell 200a of third-level cell set 510a and each second-level cell 200b of second-level cell set 512a), a key-value pair (e.g., (key=Q, value=W(O))) where Q is an identifier of the cell and W(O) is a weight (e.g., “1”) associated with the geo-object. Accordingly, a key-value pair may be returned for each combination of geo-object and associated candidate dense cell. The key-value pairs corresponding to a given-geo object may define a mapping of candidate dense cells to the geo-object.

In some embodiments, processing the geo-object set to identify a set of candidate dense cells of the geo-map may include, for each given object (O) of the geo-object set, a worker node (e.g., mapper) determining a set of covering cells that includes all of the cells (Q) at an initial max level (IML) having an area that is intersected by at least a portion of the object. Where an object (O) includes (K) connected parts (PA), for each part (PA) a point (PP) may be located inside the part (e.g., if the part (PA) has a polygonal/polyhedral geometry, one of the vertices may be selected). For each point (PP), a node at the maximum level (ML) containing the point may be identified. Each of the identified cells (Q) may be inserted into a queue (Qu1) and a covering cell set (CC). A cell (Q) may be extracted from the head/top of the queue (Qu1) and processed to identify the cell's neighbors (Q′). If the object (O) intersects a neighbor (Q′) and the neighbor (Q′) is not already in the covering cell set (CC), the neighbor (Q′) may be added to the covering cell set (CC) and the tail/bottom of the queue (Qu1).

A set of ancestors of the covering cells (ACC) may be generated that includes all of the cells (Q) of the covering cell set (CC) and the ancestors (A) of each of the cells (Q) of the covering cell set (CC).

A set of neighbors of the covering cell (NCC) may be generated. All of the cells (Q) from the set of ancestors of the covering cells (ACC) and their neighbors (Q′) may be considered. If a neighbor (Q′) is not in the covering cell set (CC) and the distance from the geo-object (O) to the cell (Q′) is at most equal to a fractional distance (Dfrac) (e.g., Frac*Dcell(Q)), then the neighbor cell (Q′) may be added to the set of neighbors of the covering cell (NCC).

All cells (Q) of the covering cell set (CC) may be added to a queue (Qu2). A cell (Q) may be extracted from the head/top of the queue (Qu2) and processed to consider all neighbors (Q′) of the cell (Q). If a neighbor cell (Q′) is not in the covering cell set (CC) or the set of neighbors of the covering cell (NCC) and a distance from the geo-object (O) to the neighbor cell (Q′) does not exceed a minimum radius (Rmin), then the neighbor cell (Q′) may be added to the set of neighbors of the covering cell (NCC) and the tail/bottom of the queue (Qu2).

For each cell (Q) in the union of the set of ancestors of the covering cells (ACC) and the set of neighbors of the covering cell (NCC) the worker node may return to a master node a key-value pair (e.g., (key=Q, value=W(O))) where W(O) is a weight (e.g., “1”) associated with the geo-object (O). The key-value pairs corresponding to a given-geo object (O) may define a mapping of candidate dense cells (Q) to the geo-object (O).

Method 400 may include processing the set of candidate dense cells to identify a set of dense cells, as depicted at block 406. Processing the set of candidate dense cells may include aggregating weighting values for cells, and filtering the candidate dense cells to identify cells having a cell-level that falls within a specified cell-level range and that are associated with an aggregate weighting that does not exceed (or otherwise satisfies) a specified weighting threshold value, and/or eliminating redundant cells having overlapping areas. As a result of the processing, the set of candidate dense cells may include cells of varying levels where most of the cells include approximately the same number of objects. Some or all of the dense cells may be associated with no more than a maximum number of geo-objects, subject to the possible exceptions of highly granular cells (e.g., cell of a maximum cell-level) being associated with a high aggregate weighing and/or a greater number of geo-objects, as discussed herein.

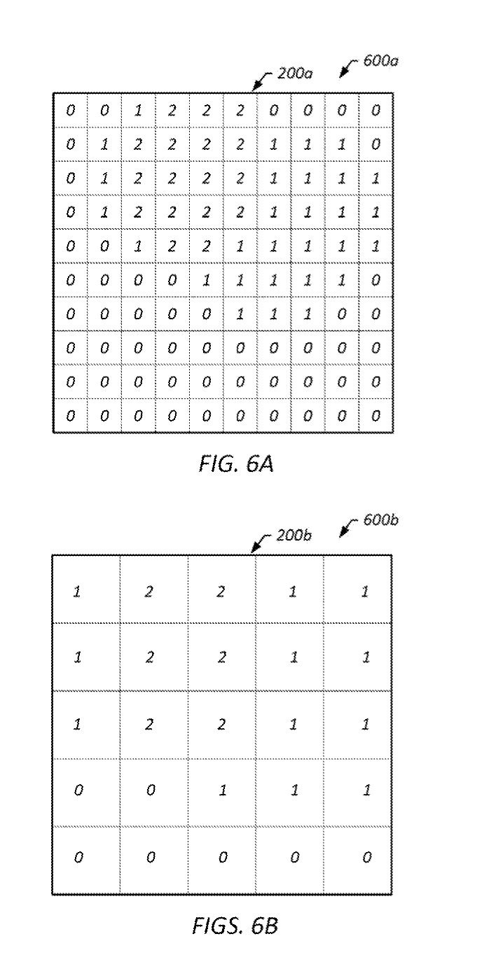

In some embodiments, processing the preliminary set of candidate dense cells may include a master node employing reduce function to generate an aggregated weight for each cell of a geo-map 106. An aggregated weight may include a sum of all of the weighting values associated with a given cell. For example, where a given cell 200 is identified as being a part of a first set of candidate dense cells corresponding to a first geo-object associated with a weighting value of “1” and as being a part of a second set of candidate dense cells corresponding to a second geo-object associated with a weighting value of “1”, the weighting values may be added to one another to generate an aggregate weighting value of “2” associated with the given candidate dense cell. FIGS. 6A and 6B depict exemplary weighted cell mappings 600a and 600b in accordance with one or more embodiments of the present technique. The mappings include an aggregate weighting value superimposed on the corresponding cells (e.g., third-level cells 200a and second-level cells 200b). Weighted cell mappings 600a and 600b may correspond to mappings 500a and 500b of FIGS. 5A and 5B such that the cell weightings are attributed to geo-objects 502a and 502b. A weighting value for each cell 200 may include an aggregate of each of the weighting values associated with the cell. For example, with regard to FIG. 6A, third-level cells 200a that are not associated with geo-object 502a or 502b (e.g. that are not part of third-level cell sets 510a or 510b) are assigned an aggregate weighting value of “0”, third-level cells 200a that are associated with only one of geo-objects 502a and 502b (e.g. that are part of only one of third-level cell set 510a or 510b) are assigned an aggregate weighting value of “1”, and third-level cells 200a that are associated with both of geo-objects 502a and 502b (e.g. that are part of third-level cell sets 510a and 510b) are assigned an aggregate weighting value of “2”. With regard to FIG. 6B, second-level cells 200b that are not associated with geo-object 502a or 502b (e.g. that are not part of second-level cell sets 512a or 512b) are assigned an aggregate weighting value of “0”, second-level cells 200b that are associated with only one of geo-objects 502a and 502b (e.g. that are part of only one of second-level cell set 512a or 512b) are assigned an aggregate weighting value of “1”, and second-level cells 200a that are associated with both of geo-objects 502a and 502b (e.g. that are part of second-level cell sets 512a and 512b) are assigned an aggregate weighting value of “2”.

In some embodiments, processing the set of candidate dense cells may include a master node employing a reduce function to identify cells of the set of candidate dense cells having a cell-level that falls within a specified cell-level range and that are associated with a weighting that does not exceed a specified weighting threshold. For example, with regard to mapping 600a and 600b of FIGS. 6A and 6B, where filtering criteria specifies that cells must have a cell-level between “2” and “3” (e.g., a cell-level range from “2” to “3”) and an aggregated weighting value that is less than or equal to “2” (e.g., weighting threshold value of “2”), all of the second and third-level cells 200b and 200a of cell sets 510a, 512a, 510b and 512b may satisfy the specified weighting threshold value and the specified cell-level range. As a result all the second and third-level cells 200b and 200a of cell sets 510a, 512a, 510b and 512b may be retained in a filtered set of candidate dense cells having cell-levels that falls within a specified range of cell-levels and having an aggregate weighting that satisfies the specified weighting threshold value.

As a further example, with regard to mapping 600a and 600b of FIGS. 6A and 6B, where filtering criteria specifies that cells a cell-level range of “2“−”3” and a weighting threshold value of “1”, the second and third-level cells 200b and 200a of cell sets 510a, 512a, 510b and 512b having an aggregated weighting value of “1” may satisfy the specified weighting threshold value and the specified range. As a result all of the second and third-level cells 200b and 200a of cell sets 510a, 512a, 510b and 512b having an aggregated weighting value of “1” may be retained in the filtered set of candidate dense cells having cell-levels that falls within a specified range of cell-levels and having a weighting that satisfies the specified weighting threshold value.

In some embodiments, a candidate dense cell having a cell-level that is equivalent to the highest cell-level of the specified cell-level range may be retained in the filtered set of candidate dense cells despite the cell having an aggregated weighting value that does not satisfy the specified weighting threshold value. For example, where filtering criteria specifies that cells a cell-level range of “2“−”3” and a weighting threshold value of “1”, third-level cells 200a having an aggregated weighting value of “2” or greater may be retained in the filtered set of cells despite the cells having aggregated weighting values that exceed the specified weighting threshold value of “1”. As a result, the filtered set of candidate dense cells may include the second-level cells 200b of cells sets 512a and 512b having an aggregated weighting value of “1” and all of the third-level cells 200a of cells sets 510a and 510. That is, only the second-level cells 200b of cells sets 512a and 512b having an aggregated weighting value of “2” or greater may be excluded from the filtered set of dense cells.

In some embodiments, processing the set of candidate dense cells may include a master node receiving, as discussed above, the key-value pairs (e.g., (key=Q, value=W(O))) that are generated for each of the cells (Q) associated with each of the objects (O). The master node may employ a reduce function to aggregate weightings (W) associated with each cell (Q) to generate an aggregate weighting value (Wagg) for each cell. The aggregate weighting value (Wagg) for a given cell (Q) may include a sum of all of the weightings (W(O)) associated with the given cell (Q). If the resulting aggregated weight (Wagg) for a given cell (Q) is less than or equal to a specified weighting threshold value (WTV) or the cell (Q) has a cell-level (CL) that is equivalent to the maximum cell-level (MxCL) of a specified cell-level range (CLR), then a key corresponding to the cell (Q) may be output. If the resulting aggregated weight (Wagg) for a given cell (Q) is greater than a specified weighting threshold value (WTV) and the cell (Q) does not have a cell-level (CL) that is equivalent to the maximum cell-level (MxCL) of a specified cell-level range (CLR), then a key corresponding to the cell (Q) may not be output. The keys that are output may correspond to cells (Q) having a cell-level (CL) that falls within a specified cell-level range and that are associated with an aggregated weighting (Wagg) that does not exceed a specified weighting threshold value (WTV). The keys may represent or otherwise be used to generate a set of candidate dense cells (FSDC).

In some embodiments, processing the set of candidate dense cells may include filtering from the set of candidate dense cells, redundant candidate dense cells (e.g., cells having overlapping areas). In some embodiments, cells of the filtered set of dense cells that have an ancestor cell (e.g., a parent) in the filtered set of cells may be removed from the filtered set of cells to generate the set of dense cells. That is, a candidate dense cell that is a child of another cell of the set of candidate dense cells is filtered out of the set of candidate dense cells. For example, where the set of filtered dense cells includes a line of ancestors (e.g., a child cell, a parent of the child cell, and a grand-parent of the child cell), only the lowest-level cell of the line of ancestors (e.g., the grand-parent cell) may be retained in the set of dense cells.

In some embodiments, processing the set of candidate dense cells may include, for each cell (Q) of the filtered set of cells (FSC), a worker node emitting a key-value pair identifying the cell itself (e.g., (key=Q, value=kCellValue)) and, for each child cell (Q′) of the cell (Q), emitting a key-value pair identifying the child (e.g., (key=Q′, value=kChildValue)). A master node may employ a reduce function where a key for a cell (Q) is kept only if the list of values for the cell contains only one value (V) and the value is (kCellValue). That is, the reduce function may only keep keys that correspond to cells (Q) that are not children of other cells of the set. The keys that are output by the master node may represent or be used to generate a set of dense cells (SDC).

Method 400 may include generating an index of dense cells and corresponding geo-objects (e.g., a cell-object index 108), as depicted at block 408. Generating a cell-object index may include generating an index that includes a listing of each cell of the set of dense cells and, for each cell, a listing of the geo-objects associated therewith. For example, where a given one of the second-level cells 200b is identified in the set of dense cells and is associated with both of objects 502a and 502b, an entry of the index may specify an identification of the cell (e.g., a cell identifier) and a listing of at least the object ID's associated with objects 502a and 502b. In the event of receiving a nearest-neighbor query corresponding to a query location including a geolocation within a given cell (e.g., a cell near objects 502a and 502b), the index may be employed to identify the listing of geo-objects associated with the given cell (e.g., geo-objects 502a and 502b). In some embodiments, the listing of geo-objects associated with the given cell may be processed to identify which of the geo-objects is nearest the query location.

FIG. 4B is a flowchart that illustrates a method 450 of generating an index of dense cells and proximate geo-objects in accordance with one or more embodiments of the present technique. Method 450 may include identifying sets of geo-objects associated with dense cells, as depicted at block 452. Identifying a set of geo-objects associated with dense cells may include, for each cell of a set of candidate dense cells, identifying geo-objects associated therewith. In some embodiments, identifying a set of geo-objects associated with a dense cells may include identifying geo-objects that are associated with a given cell based on a corresponding entry of an index (e.g., an entry of cell-object index generated at block 408 of method 400).

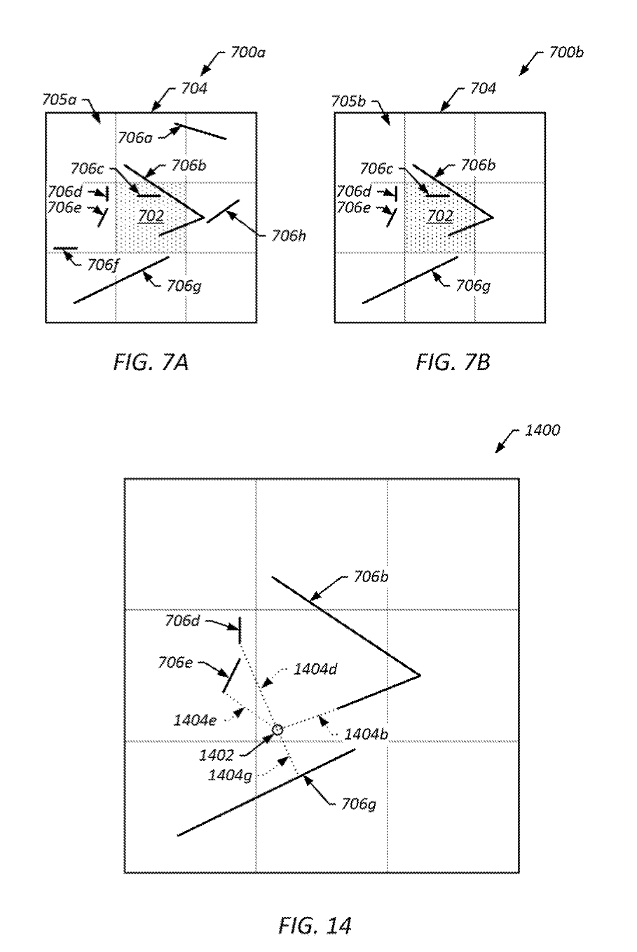

FIG. 7A is a diagram that illustrates a mapping 700a of a set of geo-objects 705a associated with a given dense cell 702 in accordance with one or more embodiments of the present technique. Set of geo-objects 705a includes eight geo-objects 706a-706h having at least a portion of their geometry located within at least one of dense cell 702 and/or eight neighboring cells 704. In some embodiments, set of geo-objects 705a may correspond to a listing of geo-objects associated with the given cell 702 as specified by an index (e.g., an entry of the cell-object index generated at block 408 of method 400, corresponding to cell 702).

Method 450 may include processing the sets of geo-objects associated with dense cells to identify filtered sets of geo-objects that are proximate to the dense cells, as depicted at block 454. In some embodiments, processing the geo-objects associated with dense cells to identify geo-objects that are proximate to dense cells of the set of candidate dense cells may include, for each given dense cell of the set of dense cells (e.g., the set of dense cells identified at block 406 of method 400), filtering the set of geo-objects associated with the dense cell to generate filtered sets of geo-objects that are nearest-neighbors to at least one point contained in the given dense cell. Filtering the set of geo-objects associated with the dense cell may include filtering-out geo-objects that cannot be a nearest-neighbor to any point contained in the given cell. For example, where at least a portion of a first of the objects associated with a dense cell is closer to every point within the dense cell than any portion of a second of the geo-objects such that the first of the geo-object is always closer than the second of the geo-objects to any point within the given cell, the first of the geo-objects may be included in the filtered set of geo-objects associated with the dense cell and the second of the geo-objects may be excluded from the filtered set of geo-objects associated with the dense cell. In some embodiments, geo-object having a geometry that intersects any portion of a given dense cell may be included in the filtered set of geo-objects associated with the dense cell.

FIG. 7B is a diagram that illustrates a mapping 700b of a filtered set of geo-objects 705b associated with dense cell 702 in accordance with one or more embodiments of the present technique. Mapping may correspond to mapping 700 including geo-objects 706a-706h. Notably, geo-objects 706a, 706f and 706h may be excluded from filtered set of geo-objects 705b as other geo-objects are closer to dense cell 702, such that geo-objects 706a, 706f and 706h are not nearest-neighbors to any point contained in dense cell 702. For example, a portion of each of geo-objects 706d and 706e are closer to any point in cell 702 than any portion of geo-object 706f. A portion geo-objects 706b is closer to any point in cell 702 than any portion of geo-objects 706a and 706h.

In some embodiments, processing the set of candidate dense cells may include, worker nodes receiving set of geometric objects (O) that are each processed in separate mapping functions. The covering cell set (CC), the set of ancestors of the covering cells (ACC), and the set of neighbors of the covering cell (NCC) are determined as discussed above. A copy (copy(O)) of the object (O) is constructed which includes the object's identifier, type, geometric representation (e.g., geometry), and the identifiers of the sets to which the object (O) belongs and/or additional information. A set of dense cells (SDC) is read into memory at each worker node. For each cell (Q) of the intersection of the set of dense cells (SDC) and the union of neighbors of the covering cell (NCC) and ancestors of the covering cells (ACC) (e.g., NCC U ACC), a worker node may emit a key-value pair (e.g., key=Q, value=copy(O)) for each cell (Q). A master node may employ a reduce function that takes, for each cell (Q), the key and list of values for the copies (copy(O)) of the objects (O) which can be potentially indexed in association with the cell (Q). Objects (O) are to be kept if for the given object (O) there exists a query for a point (P) located in the cell (Q) and an object type (ST) that the given object (O) is an answer to the query.

In some embodiments, filtering may be employed in the context of cells (Q) including two-dimensional polygons, although other embodiments may include any number of dimensions. In a two-dimensional space, each cell (Q) may include a polygon (e.g., a square for a quad tree). In a first stage of filtering, each edge of the polygon may be divided into a number (K) of equal sub-segments (S). For each object (O) in the input list (e.g., list of values for the copies (copy(O)) of the objects (O) which can be potentially indexed in association with the cell (Q)), a distance is computed from the object (O) to each sub-segment (S) of the edge of the polygon. A minimum and maximum distance between the segment and the object may be determined (e.g., dmin(S)=min{Distance(O,S)}, and dmax(S)=dmin(S)+length(S), where distance (O,S) denotes the distance between the object (O) and the sub-segment (S)). The distance between two geometric figures is the minimum distance between two points belonging to the geometric figures (e.g., if two geo-objects intersect, the distance between them is equal to zero). An output generates a list of objects (O) where an object (O) is added to the output list if it intersects the cell (Q) or is the distance from the object (O) to at least one segment (S) does not exceed the maximum distance between the segment and the object dmax(S). Filtering may include employing a function FilteringUsingDistances(Q,ObejctInputList), where ObjectInput List is the input list of objects and an output list is generated including the input objects that are not filtered out. Notably, after a first stage of filtering, there may still exist some objects which cannot be the answer to a query whose query point (P) is located inside the cell (Q).

In a second stage of filtering, every edge of the polygon may be considered. For each edge (E), a Voronoi diagram of the objects (O) restricted to the edge (E) may be computed. It may be assumed that objects (O) are points, segments or polygonal chains (but not polygons). Each object (O) may be decomposed into a collection of segments which will be processed independently. A point may be considered as a segment having a length of zero. A lower envelope of the distance functions from the segments to the currently considered cell edge (E) may be computed. The edge (E) may be equivalent to the interval [0,1] (e.g., “0” and “1” corresponding to opposite endpoints of the edge (E). Point (E,F) may denote a point located on edge (E) at a fraction (F) of the edge's length from the first endpoint. For every segment (Seg) of an object (O) from the input list a distance function (Dseg) may be defined as E(F)=Distance (Seg,Point(E,F)) on interval [0,1] and may be unimodal (e.g., it initially decreases then increases). A minimum edge fraction (Fminseg,E) may include the distance function (Dseg) attains its minimum value. Every distance function (Dseg) may be decomposed into two partial functions: one which is defined on the interval [0, Fminseg,E] and another defined on the interval [Fminseg,E, 1], where any two partial functions may intersect at only one point.

A lower envelope computation algorithm may be implemented that includes a set of disjoint intervals (except possible for their endpoints) [a(i),b(i)] having a union equal to [0,1]. For each interval [a(i),b(i)], the segment Seg(i) which is closest among all the other segments to every point Point(E,x) (a(i)≦x≦b(i)) may be stored. An exemplary pseudocode of the lower envelope computation algorithm is provided below:

```
ComputeLowerEnvelope(S: set of segments)
if |S|=1 then {
  Let Segm be the only segment in S.
  Let Fminsegm,E be the fraction at which the segment Segm is the
closest to the interval [0,1] (corresponding to the current edge E)
  Construct a lower envelope consisting of two intervals:
[a(1)=0,b(1)=Fminsegm,E]
and [a(2)=Fminsegm,E, b(2)=1] (and seg(1)=seg(2)=segm).
} else {
  Split S into two sets S1 and S2
  LE1=ComputeLowerEnvelope(S1)
  LE2=ComputeLowerEnvelope(S2)
  return MergeLowerEnvelopes(LE1,LE2)
}
```

A merging of two lower envelopes LE1 and LE2 may be performed as follows. All the interval endpoints of both lower envelopes (removing duplicates) may be sorted. Then, for every two consecutive endpoints u and v in the sorted order, there may be one segment (seg1) closest to the interval [u,v] in LE1 and one segment (seg2) closest to [u,v] in LE2. Seg1 corresponds to the interval [a(i),b(i)] of LE1 which includes [u,v]; seg2 corresponds to the interval of LE2 which includes [u,v]). The following cases may exists:
1) seg1 is closer to both u and v than seg2: then the merged lower envelope contains the segment [u,v] and seg1 is associated to it.
2) seg2 is closer to both u and v than seg1: then the merged lower envelope contains the segment [u,v] and seg2 is associated to it.
3) seg1 is closer to u than seg2 and seg2 is closer to v than seg1: then the fraction w (u≦w≦v) is computed such that seg1 and seg2 are located at equal distance from Point(E,w): the merged lower envelope will contain the intervals [u,w] (with seg1 associated to it) and [w,v] (with seg2 associated to it).
4) seg2 is closer to u than seg1 and seg1 is closer to v than seg2: then the fraction w (u≦w≦v) is computed such that seg1 and seg2 are located at equal distance from Point(E,w): the merged lower envelope will contain the intervals [u,w] (with seg2 associated to it) and [w,v] (with seg1 associated to it)

The merged lower envelope may be compacted. A rule may include the following:
if two consecutive intervals of the merged lower envelope [a(i),b(i)] and [a(i+1),b(i+1)] (where b(i)=a(i+1)) have the same segment associated to them seg(i)=seg(i+1) and b(i) is not the fraction at which the distance function of the segment seg(i) attains the minimum value on the interval [0,1], then the two intervals are merged into a single one: [a(i),b(i+1)] whose associated segment is seg(i).

Note, the fractions where minimum distances are attained for segments associated to intervals of the lower envelope may always be kept as endpoints (and not located strictly within the interior of some interval). This may provide that on every interval [u,v] of the merged lower envelope of two lower envelopes the distance functions of the two considered segments intersect in at most one point. The set (S) may be split in such a way that |S1|=|S|−1 and |S2|=1 (as opposed to splitting the set (S) into approximately equal parts).

If the objects (O) can also be polygons then they may be treated as closed polygonal chains (and decomposed them into a collection of their edges). The lower envelope may be modified as follows:
If a polygon intersects the current edge E of the cell on an interval of fractions [u,v] of non-zero length, then we change the lower envelope so that it contains the interval [u,v] with any of the polygon's edges associated to it.

Other intervals [u′,v′] completely located inside [u,v] may be removed from the lower envelope and the other intervals [u″,v″] which intersect [u,v] may be trimmed down (e.g. if [u″,v″] intersects [u,v] but does not contain [u,v] then: if u≦v″≦v we set v″=u and if u≦u″≦v we set u″=v; if [u″,v″] contains [u,v], then we split [u″,v″] into two sub-intervals [u″,u] and [v,v″] having the same segment associated to them as the former interval [u″,v″]).

The filtering stage may also be implemented as a function FilterUsingVoronoi(Q,Lobj), where Q is a cell and Lobj is the list of input objects. The function may return a list of output objects, which will contain only those objects (O) from the list of input objects (Lobj) such that:
1) object (O) intersects Cell(Q); or
2) at least one of the segments of the object (O) is the closest segment to at least one interval of the lower envelope of at least one edge of the input cell (Q).

The filtering stage may ensure that for every object (O) that is kept in the output list there exists one possible query with the query point (P) located in Cell(Q) for which the object (O) is the answer.

The two-stage filtering process described may be represented by a single function:

Filter(Q,ObjectInputList): return
FilterUsingVoronoi(Q,FilterUsingDistances(Q,ObjectInputList))

In some embodiments, the first filtering stage may not be employed. The first filtering stage may provide an efficient filtering algorithm that may filter out a large number of objects, leaving only a small number of objects to be processed by the second filtering stage. Where the second stage is processor intensive, the first filtering stage may be employed to reduce processing overhead associated with the second filtering stage.

After filtering, the aggregate weight (Wagg) of the remaining objects (O) which were not filtered out may be computed. If the aggregate weight (Wagg) is less than or equal to a weighting threshold value (WTV) (e.g., Wagg≦WTV) or the cell-level (Level(Q)) of the cell (Q) is equal to the maximum cell-level (MxCL) (e.g., Level(Q)=MxCL), then we compute a listing of cell identifiers (Lid(Q)) including of the identifiers (e.g., object ID's) of the remaining objects (O) and the identifiers of the sets to which these objects (O) belong. If the aggregate weight (Wagg) is greater than a weighting threshold value (WTV) (e.g., Wagg≧WTV) and the cell-level (Level(Q)) of the cell (Q) is less than the maximum cell-level (MxCL) (e.g., Level(Q)<MxCL), then Q may be split recursively into its children (Q′). Similar processing may be performed one each child cell (Q′) of the cell (Q). For example, the processing function, filtering of the objects, computing of aggregate weight, and so on My be performed. An exemplary pseudocode of the processing function is provided below:

```
Process(Q:cell, Lobj:list of copies of objects) {
  Lfiltered = empty
  for each type of object T do {
    Let LobjT be the list containing all the objects of type T from Lobj
    Lfiltered=Lfiltered U Filter(Q,LobjT)
  }
Wagg=the aggregate of the weights of the objects in Lfiltered
if (Wagg<=WTV) or (Level(Q)=MxCL) then {
  Lid'(Q)=the set of identifiers of the objects O from Lfiltered
and of the sets to which they belong
  Each object identifier (Oid) from Lid'(Q) contains attached to
it one identifier of a set which it belongs
to (or a special value if it belongs to no set)
  Output(Q,Lid'(Q))
  } else {
    for each child Q' of Q do
      Process(Q',Lfiltered)
    }
  }
}
```

A reduce function may construct the list of objects (Lobj) from the list of values associated to the key (Q) and call the function Process(Q,Lobj).

An output of the reduce function may include pairs (Q,Lid′(Q)), where Q is an actual dense cell (e.g., a dense cell selected at the end of phase 2 or the child of such a dense cell) and Lid′(Q) is the list of identifiers of the objects (O) which will be indexed in association with the dense cell (Q) (and of the sets to which they belong).

Method 450 may include generating an index of dense cells and proximate geo-objects (e.g., a cell-object index 108), as depicted at block 456. Generating cell-object index may include generating an index that includes a listing of each cell of the set of dense cells and, for each dense cell, a listing of the geo-objects of the filtered set of geo-objects associated therewith. For example, where a filtered set of geo-objects 705b including geo-objects 706b, 706c, 706d, 706e and 706g is associated with dense cell 702, and entry of the cell-object index may specify a identification of the dense cell (e.g., a cell identifier) and a listing that includes at least the object ID's associated with geo-objects 706b, 706c, 706d, 706e and 706g. In the event of receiving a nearest-neighbor query corresponding to a query location including a geolocation within a given cell (e.g., cell 702), the index may be employed to identify the listing of geo-objects associated with the given cell (e.g., geo-objects 706b, 700c, 700d, 700e and 700g). In some embodiments, the listing of geo-objects associated with the given cell may be processed to identify which of the geo-objects is nearest the query location.

In certain embodiments, cells proximate dense cells (“non-dense cells”) are identified and processed to identify geo-objects that are nearby the non-dense cells (e.g., within a maximum distance/radius of the non-dense cell). The non-dense cells may be associated with one or more of the geo-objects associated with nearby dense cells. In certain embodiments, a non-dense cell may be associated with a single one of the geo-objects associated with the closest set of dense cells. Associating less than all of the geo-objects with the non-dense cells may result in an approximation of the closest object as another of the geo-objects in the dense cell may be closer. Associating less than all of the geo-objects with the non-dense cells may improve performance as fewer objects may be associated with the non-dense cell and, thus, fewer geo-objects may have to be processed where a query point is located in the non-dense cell. The trade-off in accuracy and performance may be warranted as the non-dense cells may not have geo-objects located nearby (e.g., within a minimum distance/radius of the non-dense cell), and an approximation of the closest geo-object may be suitable at the extended distance. In some embodiments, a cell-object index (e.g., cell-object index 108) may include an entry for each non-dense cell associated with at least one geo-object corresponding thereto.

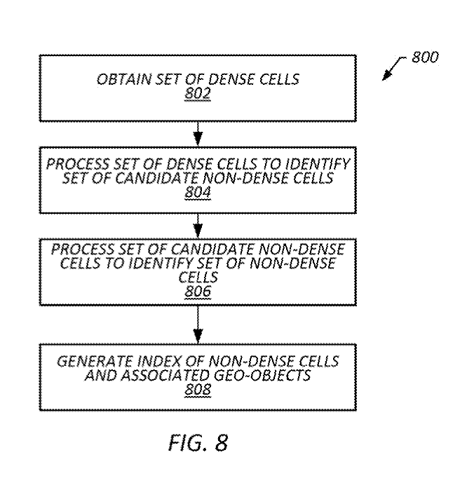

FIG. 8 is a flowchart that illustrates a method 800 of identifying a set of candidate non-dense cells in accordance with one or more embodiments of the present technique. A non-dense cell may refer to a cell that is relatively far from at least a portion of one or more geo-objects in a given space. For example, a non-dense cell may include a geographic area located a distance that is greater than a minimum radius (e.g., Rmin) and/or less than a maximum radius (Rmax) from any part of a geographic object and/or a dense cell.

Method 800 may include obtaining a set of dense cells, as depicted at block 802. The set of dense cells may include the set of dense cells identified at block 406 of method 400 as discussed above with regard to FIG. 4. Obtaining a set of dense cells may include retrieving the set of dense cells from datastore 110.

Method 800 may include processing the set of dense cells to identify a set of candidate non-dense cells, as depicted at block 804. Processing the set of dense cells to identify a set of candidate non-dense cells may include processing each of the dense cells to identify ancestors of the dense cell, neighbors of the dense cell and neighbors of the ancestor cells that each fall within a specified cell-level range, that are each within the maximum radius of the dense cell and that each do not include another dense cell located therein (e.g., a descendant that is a dense cell).

In some embodiments, each dense cell of the set of dense cells may be processed in accordance with a MapReduce technique. Such a technique may enable dense cells to be processed in parallel by one or more worker nodes to identify for each dense cell, a corresponding set of candidate non-dense cells corresponding to the dense cell. In some embodiments, input/problem 306 may define a problem requesting an identity of non-dense cells associated with each dense cell of an input set of dense cells. Input/problem 306 may include the set of dense cells, geo-map 106, and/or additional processing criteria that is provided to master node 302.

In some embodiments, additional processing criteria may specify a cell-level range (e.g., a minimum cell-level (“MinCellLevel”) and a maximum cell-level (“MaxCellLevel”)), and a maximum radius (“Rmax”). Minimum cell-level may define the lowest-level (e.g., largest cell size) to be considered during processing as described herein. Maximum cell-level may define a highest-level (e.g., smallest-cell-size) to be considered during processing as described herein.

In some embodiments, mater node 302 may divide the input/problem 306 into sub-problems that are forwarded to various worker nodes 304 for processing. For example, where the set of dense cells includes one-thousand dense cells, master node 302 may break input/problem 306 into one-thousand sub-problems 308 that are each distributed to respective ones of one-thousand different worker nodes 304. Each sub-problem 310 may correspond to a given dense cell and request an identity of non-dense cells associated with the dense cell. Each sub-problem may be processed by a given worker node 304 to identify non-dense cells that correspond to the given dense associated with the sub-problem, and the given worker node 304 may return to master node 302 a corresponding answer 310 that identifies a set of one or more non-dense cells that correspond to the given dense. Master node 302 may reduce the answers into a listing of non-dense cells and, for each of the non-dense cells, a corresponding listing of dense cells that are associated with the given non-dense cell. Embodiments may include distribution of sub-problems to any suitable number and/or logical arrangement of worker nodes.

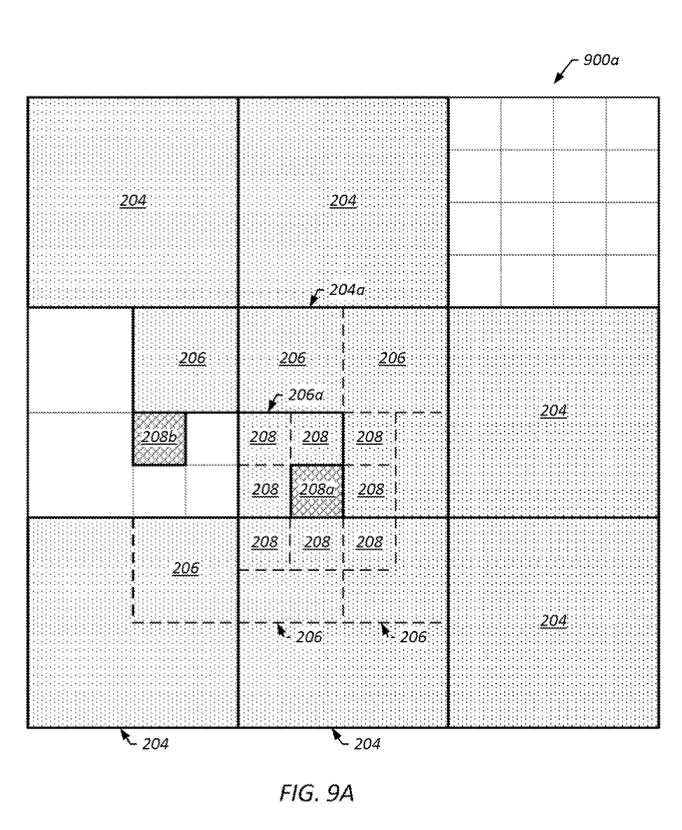

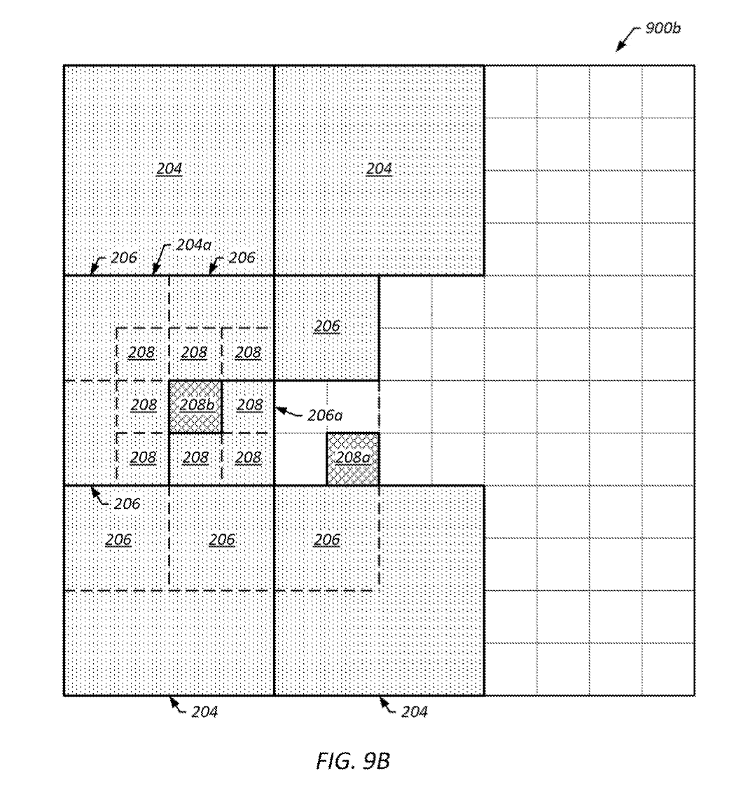

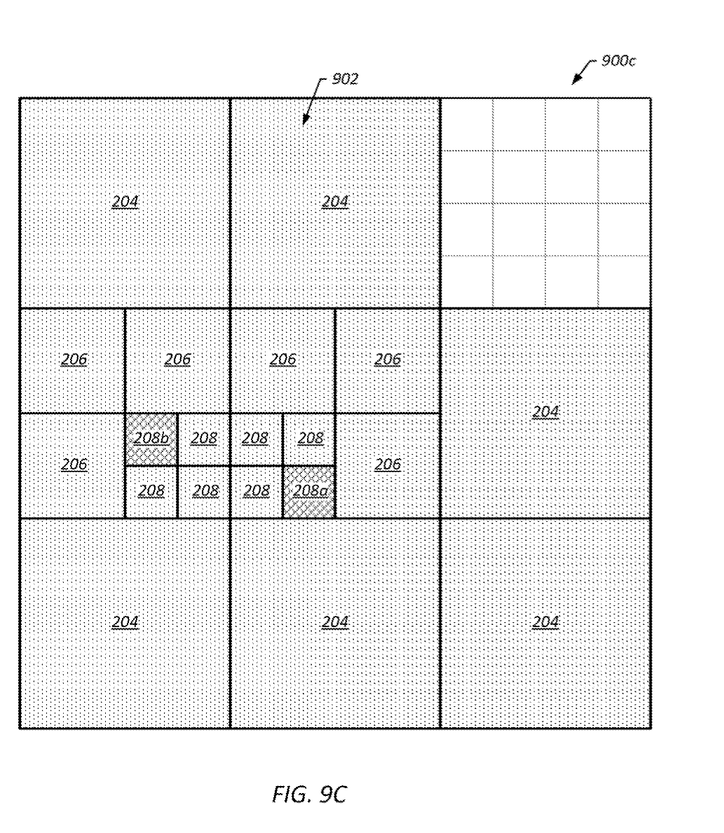

FIG. 9A is an exemplary mapping 900a of candidate non-dense cells associated with a dense cell 208a in accordance with one or more embodiments of the present technique. Mapping 900a may be representative of a plurality of second-level cells 204, a plurality of third-level cells 206 and a plurality of fourth-level cells 208. Fourth-level cells 208a and 208b may include dense cells (e.g., dense cells of the set of dense cells identified at block 406 of method 400 as discussed above). Embodiments of method 800 may be discussed with reference to mapping 900a and 900b of FIG. 9B.

In some embodiments, processing of a sub-problem corresponding to a given dense cell of the set of dense cells may include identifying a set of non-dense cells associated with the dense cell. The set of non-dense cells associated with the dense cell may include ancestors of the dense cell, neighbors of the dense cell, and neighbors of the ancestor cells, each having a cell-level that falls within a specified cell-level range and not including a descendant that is a dense cell. For example, where a problem specifies a cell range of “4” to “2” and a maximum radius of one-kilometer (e.g., Rmax=1 km), processing of the sub-problem for a given dense cell having a cell-level of “4” may include identifying third-level and second-level cells that are ancestors of the dense cell, neighbors of the dense cell, neighbors of the ancestors of the dense cell that are each within the maximum radius of the dense cell and that each do not include a descendant that is a dense cell. For example, with regard to mapping 900a of FIG. 9A, where a cell range of “4” to “2” and a maximum radius of one-kilometer is specified by problem 306, processing of a sub-problem for fourth-level dense cell 208a to identify a set of candidate non-dense cells associated with dense cell 208a may include identifying ancestor/parent third-level non-dense cell 206a and ancestor/grand-parent second-level non-dense cell 204a, identifying neighboring non-dense cells of dense cell 208 (e.g., the eight shaded fourth-level cells 208 neighboring dense cell 208a), identifying neighboring non-dense cells of the third-level non-dense ancestor/parent cell 206a (e.g., the seven shaded third-level cells 206 neighboring non-dense ancestor/parent cell 206a), and identifying neighboring non-dense cells of the second-level non-dense ancestor/parent cell 204a (e.g., the six shaded second-level cells 204 neighboring non-dense ancestor/parent cell 206a). Notably, all of the cells neighboring dense cell 208 have been identified for inclusion in the set of non-dense cells associated with dense cell 208a as none of the cells is a dense cell or has a dense cell descendant. A neighbor of ancestor/parent cell 206a (e.g., a third-level cell to the to the immediate left of cell 206a) has not been identified for inclusion in the set of candidate non-dense cells associated with dense cell 208a as the particular third-level cell includes descendant dense cell 208b. A neighbor of ancestor/grand-parent cell 204a (e.g., a second-level cell to the to the immediate left of cell 204a) has not been identified for inclusion in the set of candidate non-dense cells associated with dense cell 208a as the particular second-level cell also includes dense cell 208b as a descendant. Further, a neighbor of grand-parent cell 204a (e.g., a second-level cell above and to the right of cell 204a) has not been identified for inclusion in the set of candidate non-dense cells associated with dense cell 208a as the distance between the upper right-hand corner of dense cell 208a and the lower left-hand corner of the particular second-level cell is greater than the maximum radius (Rmax) of one-kilometer. In some embodiments, the set of candidate non-dense cells associated with dense cell 208a may include a listing identifying the shaded second third and fourth level cells 208, 206, 206a, 204 and 204a of mapping 900a of FIG. 9A.

In some embodiments, each dense cell of the set of dense cells may be processed to identify a set of candidate non-dense cells corresponding to the given dense cell. For example, where the set of dense cells includes dense cells 208a and 208b, each of dense cells 208a and 208b may be processed to identify sets of candidate non-dense cells corresponding to each of dense cells 208a and 208b, respectively.

In some embodiments, dense cells may be processed via separate sub-problems that are distributed between worker nodes. For example, dense cell 208a and dense cell 208b may be processed via two separate sub-problems that are distributed to different worker nodes 304. A first sub-problem to identify a set of candidate non-dense cells associated with dense cell 208a may be sent from master node 302 to worker node 304a, and a second sub-problem to identify a set of candidate non-dense cells associated with dense cell 208a may be sent from master node 302 to worker node 304b. Corresponding answers identifying the set of candidate non-dense cells for each dense cell may be received at master node 302.

FIG. 9B is an exemplary mapping 900b of candidate non-dense cells associated with a dense cell 208b in accordance with one or more embodiments of the present technique. Mapping 900b may be representative of a plurality of second-level cells 204, a plurality of third-level cells 206 and a plurality of fourth-level cells 208. Fourth-level cells 208a and 208b may include dense cells (e.g., dense cells of the set of dense cells identified at block 406 of method 400 as discussed above). It should be noted that, although, certain embodiments described herein may refer to two dense cells for illustrative purposes, a set of dense cells and corresponding mappings may include any number of dense cells that are processed to identify sets of candidate non-dense cells corresponding each respective dense cell. In some embodiments, dense cell 208b may be processed in a similar manner to dense cell 208b to identify a set of candidate non-dense cells corresponding thereto. For example, with regard to mapping 900b of FIG. 9B, where a cell range of “4” to “2” and a maximum radius of one-kilometer is specified by problem 306, processing of a sub-problem for fourth-level dense cell 208b to identify a set of candidate non-dense cells associated with dense cell 208b may include identifying ancestor/parent non-dense cell 206a and ancestor/grand-parent non-dense cell 204a, identifying neighboring non-dense cells of dense cell 208 (e.g., the eight shaded fourth-level cells 208 neighboring dense cell 208b), identifying neighboring non-dense cells of the third-level non-dense ancestor/parent cell 206a (e.g., the seven shaded third-level cells 206 neighboring non-dense ancestor/parent cell 206a), and identifying neighboring non-dense cells of the second-level non-dense ancestor/parent cell 204a (e.g., the four shaded second-level cells 204 neighboring non-dense ancestor/parent cell 206a). Notably, all of the cells neighboring dense cell 208 have been identified for inclusion in the set of candidate non-dense cells associated with dense cell 208b as none of the cells is a dense cell or has a dense cell descendant. A neighbor of ancestor/parent cell 206a (e.g., a third-level cell to the to the immediate right of cell 206a) has not been identified for inclusion in the set of candidate non-dense cells associated with dense cell 208b as the particular third-level cell has a descendant dense cell 208a. A neighbor of ancestor/grand-parent cell 204a (e.g., a second-level cell to the to the immediate right of cell 204a) has not been identified for inclusion in the set of non-dense cells associated with dense cell 208b as the particular second-level cell also includes the descendant dense cell 208a. Notably, other second-level cells 204 may exist to the left of mapping 900b that could be included in the set of candidate non-dense cells associated with dense cell 208b, however, the mapping does not extend that far for illustrative purposes. For the purposes of explanation, it may be assumed that the second-level cells 204 to the left of mapping 900b each include a dense cell and, thus are not included in the set of candidate non-dense cells associated with dense cell 208b. In some embodiments, the set of candidate non-dense cells associated with dense cell 208b may include a listing identifying the shaded second third and fourth level cells 208, 206, 206a, 204 and 204a of mapping 900b of FIG. 9B.

The set of candidate non-dense cells may be included in an answer provided from a worker node to a master node. For example, an answer 810 from worker node 304a to master node 302 may include the set of candidate non-dense cells associated with dense cell 208a and/or an answer 810 from worker node 304b to master node 302 may include the set of candidate non-dense cells associated with dense cell 208b.

In some embodiments, generating a set of candidate non-dense cells includes a worker node processing in separate mapping function calls at worker nodes, each dense cell (Q) of a set of dense cells (SDC). Ancestors (A) of the cell (Q) that fall within the specified cell-level range (e.g., MinCL≦Level(A)≦Level(Q), where MinCL is a specified minimum cell-level, Level(A) is the cell-level of the ancestor (A), and Level(Q) is the cell-level of the cell (Q)). All of the neighbor and sibling cells (A′) of each ancestor cell (A) may be considered. The mapping function may output a key-value pair (e.g., key=A′,value=kCandidateNonDenseCellValue) for a neighbor/sibling cell (A′) of the ancestor cell (A), if a distance between the cell (Q) and the neighbor/sibling cell (A′) is less than or equal to a maximum radius (Rmax) (e.g., Distance(Cell(Q),Cell(A′))≦Rmax). The maximum radius may include a threshold distance within which it is desired to answer nearest-neighbor queries and/or outside of which it is not necessarily desired to answer nearest-neighbor queries. For each ancestor cell (A) (including the cell (Q)), the map function may output a key-value pair (e.g., key=A, value=kDenseCellAncestorValue). A reduce function at a master node may output a key (Q) only if its list of associated values contains just non-dense cell values (e.g., kCandidateNonDenseCellValue) and, thus, does not contain any dense ancestor cell values (e.g., kDenseCellAncestorValue). A set of candidate non-dense cells may be generated from the cells output by the reduce function.

Method 800 may include processing the sets of candidate non-dense cells to identify a set of non-dense cells, as depicted at block 806. In some embodiments, processing the sets of candidate non-dense cells to identify/generate a set of non-dense cells may include a master node employing reduce function to filter redundant cells from the set of candidate non-dense cells. Such filtering may identify/generate a set of non-dense cells that includes the lowest-level cells in the set that do not include a dense cell descendant.

In some embodiments, filtering redundant cells includes filtering, from the set of candidate non-dense cells, candidate non-dense cells that have an ancestor (e.g., a parent) in the set of candidate non-dense cells. That is, where the set of candidate non-dense cells includes a line of ancestors (e.g., a child cell, a parent of the child cell, and a grand-parent of the child cell), only the lowest-level cell of the line of ancestors (e.g., the grand-parent cell) may be retained in the filtered set of non-dense cells. For example, with regard to mappings 900a and 900b of FIGS. 9A and 9B, where the set of candidate non-dense cells includes the second-level cell 204a in the lower left-hand corner as well as the two of the four third-level cells 206 contained therein (as depicted in FIG. 9B), the third-level cells 206 may be filter-out.

In some embodiments, filtering redundant cells includes filtering, from the set of candidate non-dense cells, candidate non-dense cells that are descendants of a dense cell (e.g., children of dense cells). For example, with regard to mappings 900a and 900b of FIGS. 9A and 9B, were the set of candidate non-dense cells to include fifth-level cells that are children of dense cell 208a, the fifth-level cells that are children of dense cell 208a would be filtered out.

FIG. 9C is an exemplary mapping 900c of a filtered set of non-dense cells 902 associated with a dense cells 208a and 208b in accordance with one or more embodiments, of the present technique. The filtered set of non-dense cells 902 may include the shaded second-level cells 204, a plurality of third-level cells 206 and a plurality of fourth-level cells 208 that remain after filtering out candidate non-dense cells that have a parent in the set of candidate non-dense cells and/or cells that are descendants of a dense cell. In some embodiments, the set of non-dense cells may include the cells of the set of candidate non-dense cells 902

Method 800 may include generating an index of non-dense cells and associated geo-objects, as depicted at block 808. In some embodiments, generating an index of non-dense cells and associated geo-objects may include, for each non-dense cell of the set of non-dense cells, a worker node employing a mapping function to assign, to an index entry corresponding to the non-dense cell, an object ID associated with each of the dense cells that generated the non-dense cell (e.g., source dense cells) and/or a representative cell of the dense cell. The representative cell may include the highest-level ancestor of the dense cell that touches (e.g., shares an edge/boundary with) the non-dense cell. For example, where a given non-dense cell was added to the set of candidate non-dense cells based on its proximity to a first dense cell and a second dense cell, an index may associate the given non-dense cell with a first geo-object and a representative cell associated with the first dense cell (e.g., one of the objects associated with the first dense cell according to the cell-object index generated a block 406 of method 400 and/or block 706 of method 700) and a second geo-object and representative cell associated with the second dense cell (e.g., one of the objects associated with the second dense cell according to the cell-object index generated a block 406 of method 400 and/or block 706 of method 700). With regard to mapping 900c of FIG. 9C, where an index associates dense cell 208a with ten geo-objects (e.g., geo-object “1-10”) and associates dense cell 208b with ten different geo-objects (e.g., geo-object “11-20”), the second-level non-dense cell 204 in the lower left-hand corner of mapping 900c (e.g., that was generated by both dense cell 208a (e.g., see shading of FIG. 9A) and dense cell 208b (e.g., see shading of FIG. 9B)), may be associated with one of geo-objects “1-10” (e.g., geo-object “3”) and the representative cell 204, and one of geo-objects “11-20” (e.g., geo-object “14”) and the representative cell 204. Notably, the particular geo-object to be associated with the non-dense cell may be chosen arbitrarily from the list of objects associated with the source dense cell. As a further example, the second-level non-dense cell 204 in the lower right-hand corner of the mapping that was generated by dense cell 208a (e.g., see shading of FIG. 9A) and not dense cell 208b (e.g., see shading of FIG. 9B) may be associated with one of objects “1-10” (e.g., object “2”) associated with the first dense cell 208a and the representative cell 204). By associating the non-dense cell with fewer than all of the geo-objects associated with the source cell(s) (e.g., one geo-object associated with each source dense cell), the total number of geo-objects associated with each non-dense cell may be reduced, thereby reducing the processing load with regard to determining geo-objects located near points within the non-dense cell. The resulting listings of geo-objects and representative nodes for each non-dense cell of the set of non-dense cells may be returned as an answer to a master node.

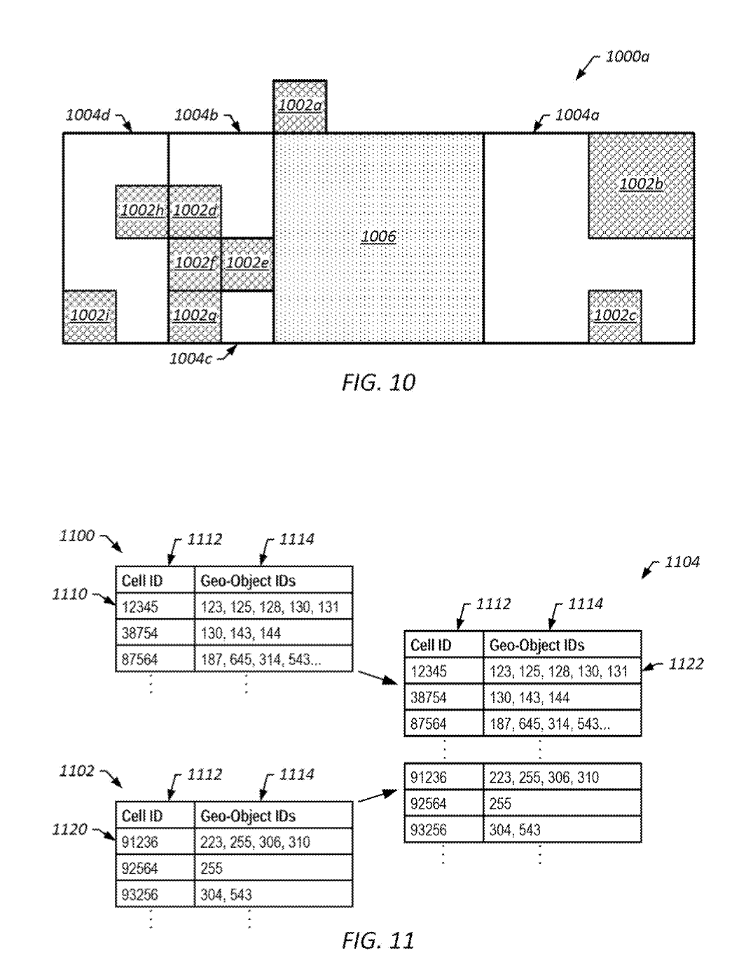

FIG. 10 is an exemplary mapping 1000a of dense cells 1002a-1002i and representative cells 1004a-1004d associated with a non-dense cell 1006 in accordance with one or more embodiments of the present technique. Non-dense cell 1006, representative cell 1004b and representative cell 1004c may each include a second-level cell. Dense cell 1002b, representative cell 1004b and representative cell 1004c may each include a third-level cell. Dense cells 1002a and 1002c-1002i may each include a fourth-level cell.

In some embodiments, a geo-object corresponding to dense cell 1002a and a representative cell of dense cell 1002a may be associated with non-dense cell 1006. A geo-object corresponding to dense cell 1002b and a representative cell 1004a may be associated with non-dense cell 1006. A geo-object corresponding to dense cell 1002c and a representative cell 1004a may be associated with non-dense cell 1006. A geo-object corresponding to dense cell 1002d and a representative cell 1004b may be associated with non-dense cell 1006. A geo-object corresponding to dense cell 1002e and a representative dense cell 1002e may be associated with non-dense cell 1006. A geo-object corresponding to dense cell 1002f and a representative cell 1004c may be associated with non-dense cell 1006. A geo-object corresponding to dense cell 1002g and a representative cell 1004c may be associated with non-dense cell 1006. A geo-object corresponding to dense cell 1002h and a representative cell 1004d may be associated with non-dense cell 1006. A geo-object corresponding to dense cell 1002i and a representative cell 1004d may be associated with non-dense cell 1006. A corresponding listing associating each of the object ID's and the representative cells may be generated.

In some embodiments, generating an index of non-dense cells and associated geo-objects may include a master node employing reduce function to the resulting listings of geo-objects and representative cells for each non-dense cell. Filtering may include filtering out object ID's for a dense cell where the corresponding representative cell is a strict ancestor of another representative cell corresponding to one or more other dense cells and/or, if there are multiple source dense cells having the same representative cells with regard to the non-dense cell, retaining an object ID for only one of the multiple source dense cells such that the other object ID's are filtered from the index. With regard to the mapping 1000a of FIG. 10, the representative cell 1004d may be a strict ancestor of representative nodes 1004b and/or 1004c and, thus, the object ID's corresponding to dense cells 1002h and 1002i may be filtered-out from the listing of geo-objects. Further, the representative cell 1004c may be a strict ancestor of representative cell 1002e and, thus, the object ID's corresponding to dense cells 1002f and 1002g may be filtered-out from the listing. Moreover, dense cells 1002b and 1002c may have the same representative node 1004a and, thus, an object ID may be kept from only one of the two dense cells 1002b and 1002c. As a result of filtering, an exemplary filtered listing of geo-objects corresponding to non-dense cell 1006 may include geo-object ID's corresponding to dense cells 1002a, 1002b, 1002d and 1002e.

In some embodiments, if a non-dense cell has a cell-level that is less than the minimum cell-level, then the non-dense cell will be divided into its descendants at the minimum-level of granularity. For example, where a minimum cell-level of “3” is specified, non-dense cell 1006 (having a cell level of “2”) may be sub-divided into its children, which may include third-level cells as noted above. A list of geo-objects may be computed for each of the non-dense descendants at the minimum-level. A geo-object may be associated with a given non-dense descendant at the minimum-level if the distance between the dense cell and the given non-dense descendant at the minimum-level does not exceed the maximum radius (Rmax). In some embodiments, only descendants with at least one geo-object associated therewith are retained in the listing of non-dense cells.

In some embodiments, generating an index of non-dense cells and associated geo-objects (e.g., a cell-object index) may include generating an index that includes a listing of each non-dense cell of the filtered set of non-dense cells and, for each non-dense cell, a listing of the geo-objects associated therewith. For example, where non-dense cell 1006 has a cell-level that is equal to a minimum cell-level, an entry of the cell-object index may specify an identification of the cell (e.g., a cell identifier) and a listing that includes at least one geo-object ID corresponding to each of dense cells 1002a, 1002b, 1002d and 1002e. In the event of receiving a nearest-neighbor query corresponding to a query location including a geographic location within a given non-dense cell, the cell-object index may be employed to identify the listing of geo-objects associated with the given non-dense cell. In some embodiments, the listing of geo-objects associated with the given non-dense cell may be processed to identify which of the geo-objects is nearest the query location.

In some embodiments, cell-object indexes (e.g., an index of dense cells and proximate geo-objects and an index of non-dense cells and associated geo-objects) may be merged to generate a consolidated cell-object index that includes a listing of all dense cells and non-dense cells and geo-objects corresponding thereto. In the event of receiving a nearest-neighbor query corresponding to a query location including a geographic location within a given dense cell or non-dense cell, the consolidated cell-object index may be employed to identify the listing of geo-objects associated with the given dense cell or non-dense cell. In some embodiments, the listing of geo-objects associated with the given dese cell or non-dense cell may be processed to identify which of the geo-objects is nearest the query location.

FIG. 11 illustrates exemplary index tables 1100, 1102 and 1104 in accordance with one or more embodiments of the present technique. Index table 1100 may be representative of an index of dense cells and proximate geo-objects. Index table 1100 may include a plurality of index entries 1110 that each specify a cell identifier 1112 and a set of objet identifiers 1114. The cell identifier 1112 may include an identifier (e.g., name, number, or the like) that uniquely identifies the corresponding cell from other cells of the corresponding geo-map (e.g., geo-map 106). The set of object identifiers 1114 may include a listing of one or more object identifiers (object ID's 130) corresponding to objects associated with the cell identified by cell identifier 1112. In some embodiments, an entry may be provided for each dense cell of given geo-map. In the illustrated embodiment, the first entry 1110 of index 1100 may include a cell ID “12345” that corresponds to an identifier for dense cell 702 of FIG. 7B, and object identifiers “123”, “125”, “128”, “130” and “131” may correspond to objects 706b, 706c, 706d, 706e and 706g, respectively, of FIG. 7B. Index table 1102 may be representative of an index of non-dense cells and associated geo-objects. In some embodiments, an entry 1120 may be provided for each non-dense cell of the given geo-map that has at least one geo-object associated therewith. In the illustrated embodiment, the first entry 1120 of index 1102 may include a cell ID “91236” that corresponds to an identifier non-dense cell 1006 of FIG. 7B, and object identifiers “223”, “255”, “306” and “310” may correspond to geo-objects associated with dense cells 1002a, 1002b, 1002d and 1002e, respectively, of FIG. 10. Index table 1104 may be representative of a consolidated cell-object index. Index table 1104 may include a merging of index tables 1100 and 1102 having entries 1122 based on the entries 1110 and 1120 of index tables 1100 and 1102. In some embodiments, each of index tables 1100, 1102 and/or 1104 may be stored in datastore 110.

In some embodiments, generating a set of non-dense cells includes a first set of mappers receiving a set of candidate non-dense cells. A mapping function may be employed to generate, for each candidate non-dense cell (Q) of the set of candidate non-dense cells, a key-value pair for the cell (e.g., key=Q, value=kCellValue) and a key-value pair for each child (Q′) of the candidate non-dense cell (Q) (e.g., key=Q′,value=kChildValue).

In some embodiments, generating a set of non-dense cells includes a second set of mappers receiving a set of dense cells (SDC). A mapping function may be employed to generate, for each dense cell (Q) of the set of dense cells, a key-value pair for each child (Q′) of the dense cell (Q) (e.g., key=Q′,value=kChildValue).

The key-value pairs from both sets of mappers are received by a master node. A reduce function is employed to generate a key for cells (Q) that only have an single value (e.g., kCellValue) associated therewith such the output of the reduce function may exclude keys that are associated dense cells and/or children of other non-dense cells of the set of candidate non-dense cells (SCNDC). A set of non-dense cells (NDC) may be generated from the cells output by the reduce function.

In some embodiments, a listing of object identifiers for non-dense cells is generated. A set of pairs of dense cells (Q) and corresponding listings of associated listing of object identifiers (Lid′Q) (e.g., (Q,Lid′(Q))) are received by worker nodes. The entire set of non-dense cells (SNDC) are read into the memory of the worker nodes. A mapping function may be employed to chose from the listing of object identifiers (Lid′Q) an object ID (Oid) and a set ID (Sid) corresponding thereto. Each ancestor cell (A) of the dense cell (Q) (including the dense cell (Q)) is considered, and for each neighbor or sibling (A′) of the ancestor cell (A) that belongs to the set of non-dense cells (NDC), the mapping generates a key-value pair (e.g., key=A′,value=(Oid,Sid,Q,A″)) if a distance between the dense cell (Q) and the neighbor/sibling cell (A′) is less than or equal to a maximum radius (Rmax) (e.g., Distance(Cell(Q),Cell(A′))≦Rmax). A″ may include the lowest ancestor (A) of the dense cell (Q) such that A″ is a neighbor or a sibling of some descendant of A′ (A″ may be A or some other ancestor of the dense cell (Q) on the path from Q to A). Note, the set of ancestors of a cell (Q′) contains (Q′) and the set of descendants of a cell (Q″) contains (Q″).

The keys output by the reduce function call include non-dense cells (Q). A list of object ID's associated with each cell may be computed (e.g., Lid(Q)). A tuple from the list of values associated with a cell (Q) may include an object ID (Oid), a Set ID (Sid), a dense cell (DCQ) and an ancestor of the dense cell (ADC). (e.g., (Oid, Sid, DCQ, ADCQ)). The values associated with a cell (Q) may be traversed ion an arbitrary order. An object ID (Oid) and set ID (Sid) may be added to the listing (Lid(Q)) only if:
1) none of the tuples traversed so far had the same value of ADCQ; and
2) there is no associated tuple (Oid′,Sid′,DCQ′,ADCQ′) in the list of associated values such that ADCQ′ is a (strict/only) descendant of ADCQ.

If the level of the cell (Q) is greater than or equal to the minimum cell-level (MinCL) (e.g., Level(Q)≧MinCL), then a pair (e.g., (Q,LidQ) is output for the cell (Q). If the level of the cell (Q) is less than the minimum cell-level (MinCL) (e.g., Level(Q)<MinCL), then the descendents (Q′) of the cell(Q) at the minimum cell-level (MinCL) are computed. For each descendent (Q′), a listing of associated object ID's is computed (e.g., Lid(Q′)). The listing (Lid(Q′)) for the descendent cell (Q′) may be computed in a similar manner as the listing (Lid(Q)) for the cell (Q), with the condition that an object ID (Oid) and set ID (Sid) may be added to the listing (Lid(Q′)) from a tuple (Oid, Sid, DCQ, ADCQ) if:
3) the distance between the dense cell (DCQ) and the descendent cell (Q′) is less than or equal to the maximum radius (Rmax) (e.g., Distance(Cell(DCQ),Cell(Q′))≦Rmax).

A set of actual non-dense cells (NDC) may be generated from the cells for which a list of values is output by the reduce function.

In some embodiments, a first set of worker nodes receives the pairs (Q,Lid′(Q)) for dense cells (Q). The object identifiers (Oid) from the list (Lid′(Q)) are “cleaned” (e.g., the attached set ID (Sid) is removed) to generate the set (Lid(Q)). The mapping function outputs a key-value pair (e.g., key=Q, value=Lid(Q)) for each dense cell. A second set of worker nodes processed the pairs (Q,Lid(Q)) for actual non-dense cell to generate key-value pair (e.g., key=Q, value=Lid(Q)) for each non-dense cell. The outputs of the two mapping functions may be aggregated to generate pairs (Q,Lid(Q)).

In some embodiments, a first set of worker nodes receives the pairs (Q,Lid′(Q)) for dense cells (Q). The object identifiers (Oid) from the list (Lid′(Q)) are “cleaned” (e.g., the attached set ID (Sid) is removed) and the mapping function iterates through every identifier (Oid) of the list (Lid(Q)) and outputs a key-value pair (key=oid, value=Q) for each such identifier. A second set of worker nodes employs a similar mapping function to iterate through every identifier (Oid) of the list (Lid(Q)) for actual non-dense cells and outputs a key-value pair (key=oid, value=Q) for each such identifier. The output includes pairs (Oid, Lcell(Oid)), where Oid is the identifier of an object (O) (or of a set) and Lcell(Oid) is the list of cells in association with which the object (O) (or the set) must be indexed.

A reduce function may be employed to generate a key including an object identifier (Oid) and the associated list of values including the cells that compose Lcell(Oid). The values are added into Lcell(Oid) and the pair (Oid,Lcell(Oid)) is output.

In some embodiments, the index tables generated may be employed to provide answers to nearest-neighbor queries. For example, in the context of a nearest-neighbor query requesting an identity and/or other information for a geo-object that is located nearest a given geo-location (e.g., a query location), a cell of a geo-map including the query location may be identified, an entry of the index tables corresponding to the cell and listing the geo-objects associated with the cell may be accessed, the geo-objects associated with the cell may be identified, geometry of the geo-objects may be considered to determine distances of the objects from the query location, a set of one or more of the geo-object determined to be closest to the query location may be identified, and the identity and/or other information for each of the one or more of the geo-object determined to be closest to the query location may be identified returned to satisfy the nearest-neighbor query.

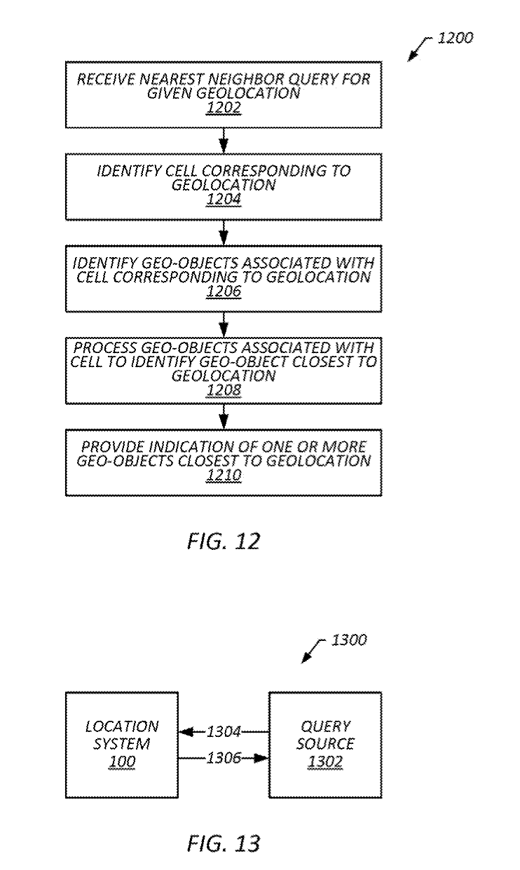

FIG. 12 is a flowchart that illustrates a method 1200 of serving a nearest-neighbor query in accordance with one or more embodiments of the present technique.

Method 1200 may include receiving a nearest-neighbor query corresponding to a given geolocation, as depicted at block 1202. In some embodiments, a nearest-neighbor query may be received from a query source. FIG. 13 is a block diagram that illustrates a nearest-neighbor query system (“system”) 1300 in accordance with one or more embodiments of the present technique. System 1300 may include a query source 1302 communicatively coupled to location system 100. Query source 1302 may be communicatively coupled to system 100 via a network, such as a local area network (LAN) and/or the Internet. In some embodiments, query source 1302 may include a device/system that transmits a nearest-neighbor query (“query”) 1304 to location system 100. In some embodiments, query source 1302 may include a user device, such as a computer, cellular phone, mapping device or the like. In some embodiments, query source 1302 may include a map server that forwards query 1304 in response to receiving generating a corresponding nearest-neighbor request. For example, a map server may receive from a user device, a map request for a geographic map including icons representing gas stations near a given geolocation, and the map server may transmit a corresponding nearest-neighbor query 1304 for gas stations near the given geolocation. In some embodiments, query source 1302 may include a computer device that is similar to computer system 2000 discussed below with regard to FIG. 15.

In some embodiments, query 1304 may specify a geographic location and/or a type/category of a geo-object of interest. For example, query 1304 may specify geographic coordinates (e.g., latitude and longitude) corresponding to a location of a device employed by a user to initiate the query and/or a type/category of “gas-stations”.

Method 1200 may include identifying a cell corresponding to the geolocation, as depicted at block 1204. In some embodiments, identifying a cell corresponding to the geolocation may include identifying, for the given geolocation, all of the cells of differing cell-levels that include the geolocation. For example, upon receiving query 1304 specifying a geo-graphic coordinates (e.g., a given latitude and longitude), the line of ancestors within which the geographic coordinate is located may be identified. In some embodiments, the range of cell-levels to be considered may be limited. For example, the cells to be identified may be limited to second and third-level cells such that only the second and third level cell containing the geographic coordinate are identified. Where query 1304 specifies a geolocation that falls within the area of cell 702 of FIG. 7B having the cell ID “12345” and also falls within the area of a child of cell 702 having a cell ID “54332”, the cells “12345” and “54332” may be identified as a cells corresponding to the geolocation.

In some embodiments, identifying a cell corresponding to the geolocation may include searching an index for entries corresponding to the identified cell. For example, consolidated cell-object index 1104 may be searched for entries corresponding to cells IDs “12345” and “54332”. Notably, where the cells and objects of a geo-mapping have been processed in accordance with the techniques described herein (e.g., methods 400, 700 and/or 800), each given geolocation (e.g., a point corresponding to a given latitude and longitude) may correspond to a single cell of an index as listings of redundant cell may be filtered from the index. For example, index 1104 of FIG. 11 may include a given entry 1122 corresponding to the cell ID “12345”, but may not include an entry corresponding to the cell ID “54332”. Accordingly, cell 702 of FIG. 7B having cell ID “12345” may be identified as a cell corresponding to the geolocation.

Method 1200 may include identifying geo-objects associated with the cell corresponding to the geolocation, as depicted at block 1206. In some embodiments, identifying geo-objects associated with a cell corresponding to the geolocation may include identifying geo-objects listed in an entry corresponding to the cell identified. For example, index table 1104 may be accessed, a given entry 1122 corresponding to cell identifier “12345” may be identified, and object identifiers “123”, “125”, “128”, “130” and “131” of entry 1122 and corresponding to geo-objects 706b, 706c, 706d, 706e and 706g, respectively, may be identified such that geo-objects 706b, 706c, 706d, 706e and 706g may be identified as corresponding to the specified geolocation of the query.

In some embodiments, identifying geo-objects associated with a cell corresponding to the geolocation may include identifying objects corresponding to a given type/category. For example, where query 1304 specifies a nearest-neighbor query for “gas-stations”, the geo-objects corresponding to the identified cell may be filtered such that geo-objects of the type/category “gas-stations” remain and geo-objects that are not of the type/category “gas-stations” are excluded from the identified geo-objects. Where each of geo-objects 706b, 706d, 706e and 706g correspond to a “gas-station” type/category, and geo-object 702c corresponds to a “park”, geo-object 702c may be filtered out such that geo-objects 706b, 706d, 706e and 706g corresponding to a “gas-station” type/category are identified as geo-objects associated with the cell.

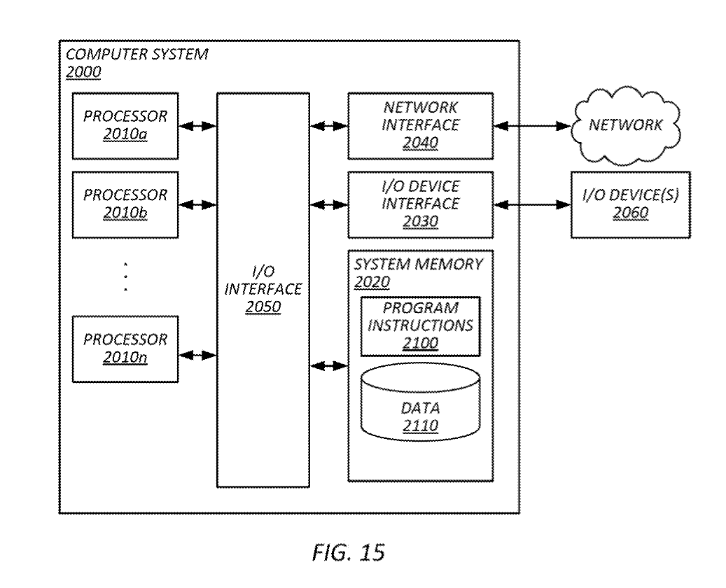

Method 1200 may include processing the geo-objects associated with the cell to identify one or more geo-objects closest to the geolocation, as depicted at block 1208. In some embodiments, processing the geo-objects associated with the cell to identify one or more geo-objects closest to the geolocation may include, for each of the geo-object associated with the cell corresponding to the geolocation, determining the distance between the specified geolocation and the closest portion of the geo-object (e.g., the minimum distance between the geolocation and the geo-object) and identifying a set of one or more of the geo-objects closest to the geolocation (e.g., the one or more geo-objects associated with the smallest minimum distances). For example, where geo-object objects 706b, 706d, 706e and 706g are identified as corresponding to the specified geolocation, a minimum distance may be determined between the specified geolocation and each of the geo-objects 706b, 706d, 706e and 706g. FIG. 14 is an exemplary mapping 1400 including a specified geolocation 1402 and geo-object objects 706b, 706d, 706e and 706g in accordance with one or more embodiments of the present technique. Mapping 1400 includes dotted lines representing minimum distances 1404b, 1404d, 1404e and 1404g between the specified geolocation and each of the geo-objects 706b, 706d, 706e and 706g, respectively. In an exemplary embodiment, minimum distances 1404b, 1404d, 1404e and 1404g may be determined to be about 0.5 km, 0.7 km, 0.4 km and 0.25 km, respectively. Accordingly, geo-object 706g may be the closest to specified geolocation 1402, with geo-objects 706e, 706b and 706d being the second, third and fourth closest, respectively.

Method 1200 may include providing an indication of one or more geo-objects closest to the geolocation, as depicted at block 1210. Where query 1304 requests an identity and/or other information about one or more geo-objects that are closest to the geolocation, location system 100 may transmit, to query source 1302, an answer 1306 including an identity and/or other information associated with the geo-object(s) determined to be the closest to the geolocation. For example, where query 1304 requests an identity and/or other information about a geo-object that is closest to geolocation 1402, location system 100 may transmit to query source 1302, an answer 1306 including geo-object dataset 120 corresponding to geo-object 706g that was determined to be closest to geolocation 1402. Where query 1304 requests an identity and/or other information about the three geo-objects that are closest to geolocation 1402, location system 100 may transmit to query source 1302, an answer 1306 including geo-object datasets 120 corresponding to the three geo-objects 706g, 706e and 706b that were determined to be closest to geolocation 1402. In some embodiments, answer 1306 may include the minimum distance determined for each of the one or more geo-objects identified as being closest to the geolocation.

Although the above embodiments of method 1220 have been discussed with regard to a geo-location that falls within a dense cell (e.g., cell 702), a similar method may be employed with regard to a geo-location that falls within a non-dense cell. For example, where a geolocation specified by query 1304 falls within non-dense cell 1006 (see FIG. 10), the corresponding cell ID of “91236” may be identified as cell corresponding to the geolocation, geo-objects corresponding to object ID's “223”, “255”, “306” and “310” may identified based on the entry 1122 corresponding to cell ID “91236”, the geo-objects corresponding to object ID's “223”, “255”, “306” and “310” may be processed to identify one or more of the geo-objects closest to the geolocation, and an answer 1306 including one or more geo-object datasets and or minimum distances corresponding to each of the geo-objects determined to be closest to geolocation may be provided.

Methods 400, 450, 800 and 1200 are exemplary embodiments of methods employed in accordance with techniques described herein. Methods 400, 450, 800 and 1200 may be may be modified to facilitate variations of its implementations and uses. Methods 400, 450, 800 and 1200 may be implemented in software, hardware, or a combination thereof. Some or all of methods 400, 450, 800 and 1200 may be implemented by location module 102. The order of methods 400, 450, 800 and 1200 may be changed, and various elements may be added, reordered, combined, omitted, modified, etc.

Exemplary Computer System

FIG. 15 is a diagram that illustrates an exemplary computer system 2000 in accordance with one or more embodiments of the present technique. Various portions of systems and methods described herein, may include or be executed on one or more computer systems similar to system 2000. For example, system 100 may include a configuration similar to at least a portion of computer system 2000. Further, methods/processes/modules described herein (e.g., module 102) may be executed by one or more processing systems similar to that of computer system 2000.

Computer system 2000 may include one or more processors (e.g., processors 2010a-2010n) coupled to system memory 2020, an input/output I/O device interface 2030 and a network interface 2040 via an input/output (I/O) interface 2050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 2000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 2020). Computer system 2000 may be a uni-processor system including one processor (e.g., processor 2010a), or a multi-processor system including any number of suitable processors (e.g., 2010a-2010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 2000 may include a computer system employing a plurality of computer systems (e.g., distributed computer systems) to implement various processing functions.

I/O device interface 2030 may provide an interface for connection of one or more I/O devices 2060 to computer system 2000. I/O devices may include any device that provides for receiving input (e.g., from a user) and/or providing output (e.g., to a user). I/O devices 2060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 2060 may be connected to computer system 2000 through a wired or wireless connection. I/O devices 2060 may be connected to computer system 2000 from a remote location. I/O devices 2060 located on remote computer system, for example, may be connected to computer system 2000 via a network and network interface 2040.

Network interface 2040 may include a network adapter that provides for connection of computer system 2000 to a network. Network interface may 2040 may facilitate data exchange between computer system 2000 and other devices connected to the network. Network interface 2040 may support wired or wireless communication. The network may include an electronic communication network, such as the Internet, a local area network (LAN), a wide area (WAN), a cellular communications network or the like.

System memory 2020 may be configured to store program instructions 2100 and/or data 2110. Program instructions 2100 may be executable by a processor (e.g., one or more of processors 2010a-2010n) to implement one or more embodiments of the present technique. Instructions 2100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 2020 may include a tangible program carrier and/or a non-transitory computer readable storage medium having program instructions stored thereon. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 2020 may include a non-transitory computer readable storage medium may have program instructions stored thereon that are executable by a computer processor (e.g., one or more of processors 2010a-2010n) to cause the subject matter and the functional operations described herein. A memory (e.g., system memory 2020) may include a single memory device and/or a plurality of memory devices (e.g., distributed memory devices).

I/O interface 2050 may be configured to coordinate I/O traffic between processors 2010a-2010n, system memory 2020, network interface 2040, I/O devices 2060 and/or other peripheral devices. I/O interface 2050 may perform protocol, timing or other data transformations to convert data signals from one component (e.g., system memory 2020) into a format suitable for use by another component (e.g., processors 1010a-1010n). I/O interface 2050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 2000, or multiple computer systems 2000 configured to host different portions or instances of embodiments. Multiple computer systems 2000 may provide for parallel or sequential processing/execution of one or more portions of the techniques described herein.

Those skilled in the art will appreciate that computer system 2000 is merely illustrative and is not intended to limit the scope of the techniques described herein. Computer system 2000 may include any combination of devices and/or software that may perform or otherwise provide for the performance of the techniques described herein. For example, computer system 2000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 2000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2000 may be transmitted to computer system 2000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method, comprising:
for each geographic object of a geo-object set:
identifying, using a computer, one or more geographic cells of a geographic mapping that each correspond to a geographic area proximate to at least a portion of a geometry of the geographic object; and
assigning a weighting value to each of the one or more geographic cells identified as corresponding to a geographic area proximate to at least a portion of a geometry of the geographic object such that the one or more geographic cells are associated with the geographic object;
for each geographic cell assigned one or more weighting values, aggregating the one or more weighting values assigned to the geographic cell to generate an aggregated weighting value for the geographic cell;
identifying a set of dense geographic cells, each geographic cell of the set of dense geographic cells having an aggregated weighting value that satisfies a weighting threshold criteria; and
generating an index associating each of the one or more geographic cells of the set of dense geographic cells with one or more geographic objects associated with the geographic cell.

2. The method of claim 1, wherein the weighting threshold criteria requires that for a geographic cell to be included in the set of dense geographic cells, the geographic cell must not be a child of another geographic cell of the set of dense geographic cells and at least one of the following conditions is satisfied:
the geographic cell is associated with an aggregated weighting value that does not exceed a weighting threshold value; and
a cell-level of the geographic cell is equivalent to a maximum cell-level of a specified cell-level range.

3. The method of claim 1, wherein the aggregated weighting value for a geographic cell is indicative of a number of geographic objects associated with the geographic cell.

4. The method of claim 1, wherein the aggregated weighting value for a geographic cell is directly proportional to a number of geographic objects associated with the geographic cell.

5. The method of claim 1, wherein each geographic cell of the set of dense geographic cells has a cell-level that falls within a specified cell-level range.

6. The method of claim 1, wherein identifying one or more geographic cells of a geographic mapping that each correspond to a geographic area proximate to at least a portion of a geometry of the geographic object comprises identifying one or more cells of the geographic mapping having at least portion of the their geographic area within a specified minimum radius of at least a portion of the geometry of the geographic object.

7. The method of claim 1, further comprising for each geographic cell of the set of dense geographic cells, disassociating, from the geographic cell, geographic objects that could never be determined to be the closest geographic object to a geographic location within the geographic cell such that the index does not associate geographic cells with geographic objects that could never be the closest geographic object to a geographic location within the geographic cell.

8. The method of claim 1, further comprising, for each geographic cell of the set of dense geographic cells:
identifying one or more geographic objects associated with the geographic cell;
for each of the one or more geographic objects associated with the geographic cell:
determining whether any portion of the geographic object is closer to any portion of the cell than all portions of all of the other geographic objects associated with the geographic cell; and
in response to determining that any portion of the geographic object is not closer to any portion of the cell than all portions of all of the other geographic objects associated with the geographic cell, disassociating the geographic object from the geographic cell, wherein the index does not associate the geographic object with the geographic cell.

9. The method of claim 1, further comprising:
receiving a nearest-neighbor query specifying a geographic location located within a geographic area of a given one of the geographic cells of the set of dense cells;
accessing the index to identify one or more geographic objects associated with the given one of the geographic cells of the set of dense cells; and
identifying at least one of the one or more geographic objects associated with the given one of the geographic cells of the set of dense cells that is closest to the geographic location specified by the query; and
generating a response indicative of the at least one of the one or more geographic objects associated with the given one of the geographic cells of the set of dense cells that are identified as being closest to the geographic location specified by the query.

10. The method of claim 1, further comprising,
for each geographic cell of the set of dense geographic cells:
identifying a set of non-dense cells comprising one or more geographic cells of the geographic mapping that each correspond to a geographic area proximate to at least a portion of the geographic cell of the set of dense geographic cell; and
associating the geographic cell of the set of dense geographic cells with each geographic cell of the set of non-dense cells; and
for each geographic cell of each set of non-dense cells identified:
identifying geographic cells of the set of dense cells associated with the geographic cell;
identifying, for each geographic cell of the set of dense cells associated with the geographic cell, a geographic object associated with the geographic cell of the set of dense cells; and
aggregating the geographic objects identified into a set of geographic objects corresponding to the geographic cell;
wherein the index associates each geographic cell of each set of non-dense cells with the set of geographic objects corresponding to the geographic cell.

11. The method of claim 10, wherein each geographic cell of the set of non-dense cells does not have a descendant geographic cell that is a geographic cell of the set of dense geographic cells.

12. The method of claim 10, wherein each geographic cell of the set of non-dense cells each have a cell-level that falls within a specified cell-level range.

13. The method of claim 10, wherein each geographic cell of the set of non-dense cells is at least one of a neighbor of the geographic cell of the set of dense geographic cells, an ancestor of the geographic cell of the set of dense geographic cells, and a neighbor of an ancestor of the geographic cell of the set of dense geographic cells.

14. The method of claim 10, wherein each geographic cell of the set of non-dense cells has at least a portion of its geographic area within a specified maximum radius of at least a portion of a geographic area of the geographic cell of the set of dense geographic cells.

15. The method of claim 10, wherein identifying, for each geographic cell of the set of dense cells associated with the geographic cell, a geographic object associated with the geographic cell of the set of dense cells comprises selecting a single one of one or more objects associated with the geographic cell of the set of dense cells.

16. The method of claim 10, further comprising:
receiving a nearest-neighbor query specifying a geographic location located within a geographic area of a given one of the geographic cells of the set of non-dense cells;
accessing the index to identify one or more geographic objects associated with the given one of the geographic cells of the set of non-dense cells; and
identifying at least one of the one or more geographic objects associated with the given one of the geographic cells of the set of non-dense cells that is closest to the geographic location specified by the query; and
generating a response indicative of the at least of the one or more geographic objects associated with the given one of the geographic cells of the set of non-dense cells that is identified as being closest to the geographic location specified by the query.

17. The method of claim 1, wherein the index is generated and stored in memory prior to receiving a nearest-neighbor query.

18. A non-transitory computer readable storage medium having computer-executable program instructions stored thereon, the program instructions executable by a computer to cause steps comprising:
for each geographic object of a geographic object set:
identifying, using a computer, one or more geographic cells of a geographic mapping that each correspond to a geographic area proximate to at least a portion of a geometry of the geographic object; and
assigning a weighting value to each of the one or more geographic cells identified as corresponding to a geographic area proximate to at least a portion of a geometry of the geographic object such that the one or more geographic cells are associated with the geographic object;
for each geographic cell assigned one or more weighting values, aggregating the one or more weighting values assigned to the geographic cell to generate an aggregated weighting value for the geographic cell;
identifying a set of dense geographic cells, each geographic cell of the set of dense geographic cells having an aggregated weighting value that satisfies a weighting threshold criteria; and
generating an index associating each of the one or more geographic cells of the set of dense geographic cells with one or more geographic objects associated with the geographic cell.

19. A system, comprising:
a processor;
a memory; and
a location module stored on the memory, the location module configured to be executed by the processor to cause:
for each geographic object of a geographic object set:
identifying, using a computer, one or more geographic cells of a geographic mapping that each correspond to a geographic area proximate to at least a portion of a geometry of the geographic object; and
assigning a weighting value to each of the one or more geographic cells identified as corresponding to a geographic area proximate to at least a portion of a geometry of the geographic object such that the one or more geographic cells are associated with the geographic object;
for each geographic cell assigned one or more weighting values, aggregating the one or more weighting values assigned to the geographic cell to generate an aggregated weighting value for the geographic cell;
identifying a set of dense geographic cells, each geographic cell of the set of dense geographic cells having an aggregated weighting value that satisfies a weighting threshold criteria; and
generating an index associating each of the one or more geographic cells of the set of dense geographic cells with one or more geographic objects associated with the geographic cell.

20. A computer-implemented method of generating an index associating geographic objects with geographic cells of a geo-mapping, the method comprising:
obtaining a geo-object set indicative of a plurality of geographic objects that are each associated with a given geographic location;
for each geographic object of the geo-object set, associating the geographic object with one or more dense cells, the dense cells comprising cells of the geo-mapping each having an area that is proximate the geographic object;
for each dense cell of the geo-mapping:
identifying a candidate set of geo-objects comprising the geographic objects associated with the dense cell; and
filtering the candidate set of geo-objects to generate a set of geo-objects corresponding to the dense cell, filtering the candidates set of geo-objects comprising excluding geographic objects that could not be the closest geo-object to a geographic location within the geographic cell;
for each dense cell of the geo-mapping, associating the dense cell with a set of non-dense cells comprising cells of the geo-mapping each having an area that is proximate the dense cell;
for each non-dense cell of each set of non-dense cells identifying a set of geo-objects corresponding to the non-dense cell, the set of geo-objects corresponding to the non-dense cell comprising, for each dense cell associated with the dense cell, a geo-object associated with the dense cell; and
generating an index associating each dense cell of the geo-mapping to a set of geo-objects corresponding to the dense cell and associating each non-dense cell of the geo-mapping to a set of geo-objects corresponding to the non-dense cell.

21. The method of claim 20, wherein each dense cell is associated with less than a threshold number of geographic objects or has a cell-level that is equal to a specified maximum cell-level.
